(19) United States
(12) Patent Application Publication
(10) Pub. No.: US 2025/0111605 A1
(43) Pub. Date: Apr. 3, 2025

(54) SYSTEMS AND METHODS OF ANNOTATING IN A THREE-DIMENSIONAL ENVIRONMENT

(71) Applicant: Apple Inc., Cupertino, CA (US)

(72) Inventors: David H. HUANG, San Mateo, CA (US); Randal W. LAMORE, San Francisco, CA (US); Soravis PRAKKAMAKUL, Emeryville, CA (US); Jason ROSSON, San Francisco, CA (US); Jue WANG, Sunnyvale, CA (US); Eric J. GEUSZ, San Francisco, CA (US); Eric G. THIVIERGE, Merchantville, NJ (US)

(21) Appl. No.: 18/891,984

(22) Filed: Sep. 20, 2024

Related U.S. Application Data
(60) Provisional application No. 63/586,783, filed on Sep. 29, 2023.

(51) Int. Cl. G06T 17/00; G06F 3/01; G06V 20/70

(52) U.S. Cl. CPC G06T 17/00; G06F 3/013; G06F 3/017; G06V 20/70

(57) ABSTRACT

Some examples of the disclosure are directed to systems and methods for displaying an editing a virtual scene. In some examples, an electronic device can display an immersive virtual scene. In some examples, the immersive virtual scene is shared in a communication session with other electronic devices. In some examples, the electronic device can detect user input requesting insertion and display of an annotation into the virtual scene. In some examples, the electronic device can determine user context to determine placement and content associated with the inserted annotation, and display a representation of the annotation. In some examples, the electronic device can capture a virtual screenshot of the virtual scene. In some examples, the electronic device can display a user interface providing an overview of the annotations associated with the virtual scene.

### CROSS REFERENCE TO RELATED APPLICATIONS

This application claims the benefit of U.S. Provisional Application No. 63/586,783, filed Sep. 29, 2023, the entire disclosure of which is herein incorporated by reference for all purposes.

### FIELD OF THE DISCLOSURE

This relates generally to systems and methods of displaying virtual environments and adding virtual content to the virtual environments.

### BACKGROUND OF THE DISCLOSURE

Proliferation of software and hardware capable of creating digital scenes has enabled users of electronic devices to craft special effects backdrops, computer graphics, and immersive virtual environments for cinema, software applications, interactive exhibits, and the like. Current systems facilitate creation and editing of digital scenes using computing displays, but often require input directed to computing peripherals such as joysticks, computing mice, trackpads, keyboards, and the like. Notes and annotations directed to such digital scenes, however, are spatially divorced from relevant content within the digital scenes. Moreover, entry of such notes and annotations can be inefficient using conventional computing peripherals. It can therefore be appreciated that a system that facilitates annotation of digital assets in a simulated three-dimensional environment, and improves efficiency of user input, can be desired.

### SUMMARY OF THE DISCLOSURE

Some examples of the disclosure are directed to systems and methods for inserting annotations and facilitating collaboration when viewing an at least partially virtual, three-dimensional scene. In some examples, an electronic device can present and/or display a three-dimensional environment to a user of the three-dimensional environment. In some examples, the three-dimensional environment can include representations of physical objects and/or individuals. In some examples, the three-dimensional environment can include one or more virtual objects and/or virtual assets.

In some examples, the electronic device can display one or more representations of physical individuals. In some examples, the one or more representations include a representation of a user of another electronic device engaged in a communication session with the electronic device. In some examples, the electronic device displays a virtual scene that can be shared with the other electronic device. In some examples, the virtual scene is displayed as though the user of the electronic device is present within a physical equivalent of the virtual scene. In some examples, the representations of physical individuals move relative to the virtual scene.

In some examples, the electronic device displays indications of user attention within the three-dimensional environment. In some examples, the electronic device displays indications of attention corresponding to attention of other users inspecting the virtual scene. In some examples, the electronic device detects an input requesting insertion and display of an annotation into the virtual scene, and in response to the request, displays a representation of the annotation. In some examples, the user input requesting insertion of the annotation includes an air gesture, a voice command, movement of the user's body, and/or gaze of the user directed to virtual content included in the virtual scene. In some examples, the electronic device determines a context of the user's interaction with the virtual scene and/or three-dimensional environment in response to detecting the user input requesting insertion of the annotation. In some examples, the electronic device obtains information such as text, voice recordings, movement of the user's body, and/or movement of the user's attention relative to the virtual scene in response to the user input, and associates the provided information with the inserted annotation.

In some examples, the electronic device determines the context of the user's environment to determine placement and/or orientation of a representation of the annotation. In some examples, the electronic device uses the context to determine information that is stored, and that corresponds to the representation of the annotation. In some examples, the context of the user includes the modality of the user input. In some examples, the context of the user includes parsed speech and/or natural language processing to determine semantics of the user's speech. In some examples, the visual appearance of a representation of an annotation has visual characteristics or properties that indicate an author of the corresponding annotation. In some examples, in response to detecting user input directed to a representation of an annotation, the electronic device presents information such as a recording of audio, display of text, playback of a spatial recording of a representation of an individual, playback of a recording of attention of the individual, and/or some combination thereof.

In some examples, the electronic device captures a virtual screenshot of the virtual scene. In some examples, the virtual screenshot is a virtual object that the user can annotate, similar to or the same as annotations directed to the virtual scene. In some examples, annotations inserted into the virtual screenshot can be inserted into the virtual scene by the electronic device. In some examples, the electronic device can change visual properties or characteristics of the virtual screenshot in response to movement off-angle relative to the virtual screenshot. In some examples, the electronic device can export the screenshot to another device.

In some examples, the electronic device displays a user interface providing an overview of annotations included within a virtual scene. In some examples, the user interface can sort and/or group listings and/or icons corresponding to annotations in accordance with a type of the corresponding annotation, an author that provided the annotation, and/or a chronological order of entry of the annotations. In some examples, in response to detecting user input directed to a representation of an annotation within the user interface, the electronic device can display, visually emphasize, and/or present the annotation information associated with the target of the user input.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an exemplary architecture for a device according to some examples of the disclosure.

FIGS. 3A-3L illustrate example interactions including annotation, editing, and inspection of a virtual scene according to some examples of the disclosure.

FIG. 4 illustrates a flow diagram illustrating an example process for interactions including annotation, editing, and inspection of a virtual scene according to some examples of the disclosure.

FIGS. 5A-5H illustrate example interactions with a user interface for interaction with a virtual scene according to some examples of the disclosure.

### DETAILED DESCRIPTION

Some examples of the disclosure are directed to systems and methods for inserting annotations and facilitating collaboration when viewing an at least partially virtual, three-dimensional scene. In some examples, an electronic device can present and/or display a three-dimensional environment to a user of the three-dimensional environment. In some examples, the three-dimensional environment can include representations of physical objects and/or individuals. In some examples, the three-dimensional environment can include one or more virtual objects and/or virtual assets.

In some examples, the electronic device can display one or more representations of physical individuals. In some examples, the one or more representations include a representation of a user of another electronic device engaged in a communication session with the electronic device. In some examples, the electronic device displays a virtual scene that can be shared with the other electronic device. In some examples, the virtual scene is displayed as though the user of the electronic device is present within a physical equivalent of the virtual scene. In some examples, the representations of physical individuals move relative to the virtual scene.

In some examples, the electronic device displays indications of user attention within the three-dimensional environment. In some examples, the electronic device displays indications of attention corresponding to attention of other users inspecting the virtual scene. In some examples, the electronic device detects an input requesting insertion and display of an annotation into the virtual scene, and in response to the request, displays a representation of the annotation. In some examples, the user input requesting insertion of the annotation includes an air gesture, a voice command, movement of the user's body, and/or gaze of the user directed to virtual content included in the virtual scene. In some examples, the electronic device determines a context of the user's interaction with the virtual scene and/or three-dimensional environment in response to detecting the user input requesting insertion of the annotation. In some examples, the electronic device obtains information such as text, voice recordings, movement of the user's body, and/or movement of the user's attention relative to the virtual scene in response to the user input, and associates the provided information with the inserted annotation.

In some examples, the electronic device determines the context of the user's environment to determine placement and/or orientation of a representation of the annotation. In some examples, the electronic device uses the context to determine information that is stored, and that corresponds to the representation of the annotation. In some examples, the context of the user includes the modality of the user input. In some examples, the context of the user includes parsed speech and/or natural language processing to determine semantics of the user's speech. In some examples, the visual appearance of a representation of an annotation has visual characteristics or properties that indicate an author of the corresponding annotation. In some examples, in response to detecting user input directed to a representation of an annotation, the electronic device presents information such as a recording of audio, display of text, playback of a spatial recording of a representation of an individual, playback of a recording of attention of the individual, and/or some combination thereof.

In some examples, the electronic device captures a virtual screenshot of the virtual scene. In some examples, the virtual screenshot is a virtual object that the user can annotate, similar to or the same as annotations directed to the virtual scene. In some examples, annotations inserted into the virtual screenshot can be inserted into the virtual scene by the electronic device. In some examples, the electronic device can change visual properties or characteristics of the virtual screenshot in response to movement off-angle relative to the virtual screenshot. In some examples, the electronic device can export the screenshot to another device.

In some examples, the electronic device displays a user interface providing an overview of annotations included within a virtual scene. In some examples, the user interface can sort and/or group listings and/or icons corresponding to annotations in accordance with a type of the corresponding annotation, an author that provided the annotation, and/or a chronological order of entry of the annotations. In some examples, in response to detecting user input directed to a representation of an annotation within the user interface, the electronic device can display, visually emphasize, and/or present the annotation information associated with the target of the user input. In some examples, the user interface can include selectable options that are selectable to insert and/or interact with the virtual scene.

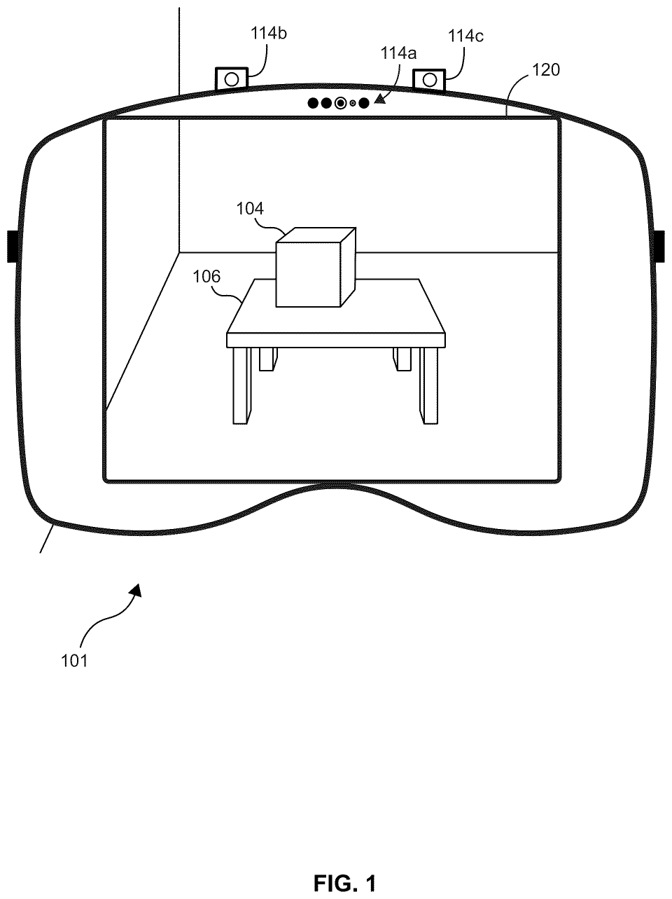

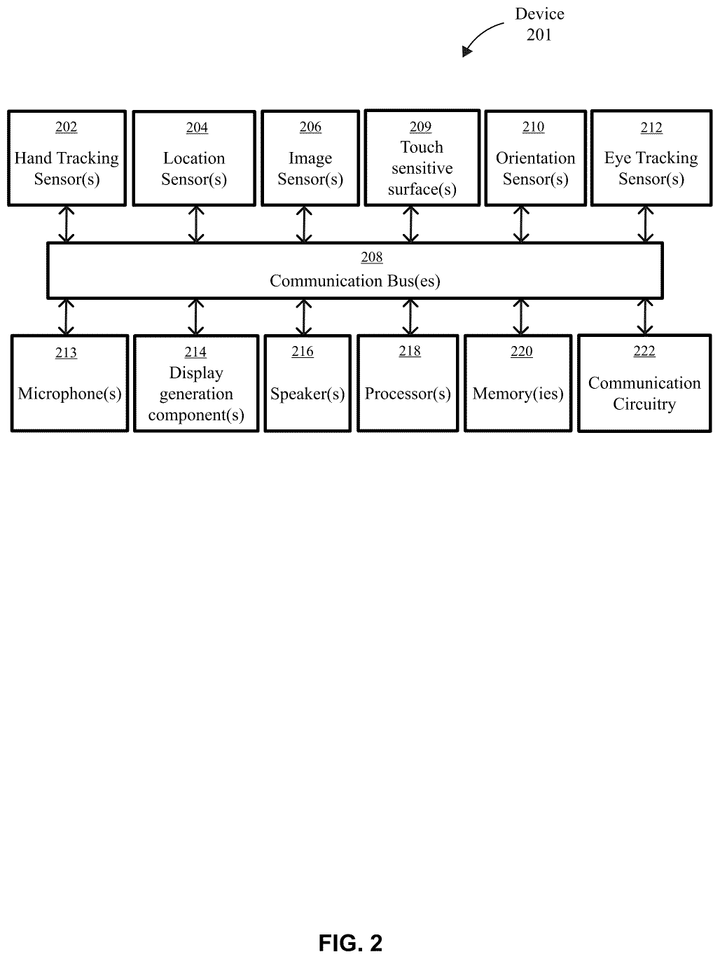

FIG. 1 illustrates an electronic device 101 presenting an extended reality (XR) environment (e.g., a computer-generated environment) according to some examples of the disclosure. In some examples, electronic device 101 is a hand-held or mobile device, such as a tablet computer, laptop computer, smartphone, or head-mounted display. Examples of device 101 are described below with reference to the architecture block diagram of FIG. 2. As shown in FIG. 1, electronic device 101 and table 106 are located in the physical environment 100. The physical environment may include physical features such as a physical surface (e.g., floor, walls) or a physical object (e.g., table, lamp, etc.). In some examples, electronic device 101 may be configured to capture images of physical environment 100 including table 106 (illustrated in the field of view of electronic device 101). In some examples, in response to a trigger, the electronic device 101 may be configured to display a virtual object 104 (e.g., two-dimensional virtual content) in the computer-generated environment (e.g., represented by a cube illustrated in FIG. 1) that is not present in the physical environment 100, but is displayed in the computer-generated environment positioned on (e.g., anchored to) the top of a computer-generated representation 106′ of real-world table 106. For example, virtual object 104 can be displayed on the surface of the computer-generated representation 106′ of the table in the computer-generated environment displayed via electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional computer-generated environment. For example, the virtual object can represent an application or a user interface displayed in the computer-generated environment. In some examples, the virtual object can represent content corresponding to the application and/or displayed via the user interface in the computer-generated environment. In some examples, the virtual object 104 is optionally configured to be interactive and responsive to user input, such that a user may virtually touch, tap, move, rotate, or otherwise interact with, the virtual object 104. In some examples, the virtual object 104 may be displayed in a three-dimensional computer-generated environment with a particular orientation. For example, the virtual object 104 may be displayed in a tilt locked orientation, a head locked orientation, a body locked orientation, or a world locked orientation in the three-dimensional environment. In some such examples, as described in more detail below, while the virtual object 104 is displayed in the three-dimensional environment, the electronic device selectively moves the virtual object 104 in response to user input (e.g., direct input or indirect input) according to the particular orientation in which the virtual object is displayed. For example, the electronic device selectively moves the virtual object 104 in response to movement of a viewpoint of the user depending on whether the virtual object 104 is body locked, head locked, tilt locked, or world locked. Additionally, it should be understood, that the 3D environment (or 3D virtual object) described herein may be a representation of a 3D environment (or three-dimensional virtual object) projected or presented at an electronic device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described herein, it should be understood that the described electronic device, display and touch-sensitive surface are optionally distributed amongst two or more devices. Therefore, as used in this disclosure, information displayed on the electronic device or by the electronic device is optionally used to describe information output by the electronic device for display on a separate display device (touch-sensitive or not). Similarly, as referred to herein, input received on the electronic device (e.g., touch input received on a touch-sensitive surface of the electronic device, or touch input received on the surface of a stylus) is optionally used to describe input received on a separate input device that is communicated to and/or indicated to the electronic device.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an exemplary architecture for a device 201 according to some examples of the disclosure. In some examples, device 201 includes one or more electronic devices. For example, the electronic device 201 may be a portable device, such as a mobile phone, smart phone, a tablet computer, a laptop computer, an auxiliary device in communication with another device, a head-mounted display, etc., respectively.

As illustrated in FIG. 2, the electronic device 201 optionally includes various sensors (e.g., one or more hand tracking sensor(s) 202, one or more location sensor(s) 204, one or more image sensor(s) 206, one or more touch-sensitive surface(s) 209, one or more motion and/or orientation sensor(s) 210, one or more eye tracking sensor(s) 212, one or more microphone(s) 213 or other audio sensors, etc.), one or more display generation component(s) 214, one or more speaker(s) 216, one or more processor(s) 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a GPS receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212, in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 can use image sensor(s) 206 (e.g., one or more IR cameras, 3D cameras, depth cameras, etc.) that capture three-dimensional information from the real-world including one or more hands (e.g., of a human user). In some examples, the hands can be resolved with sufficient resolution to distinguish fingers and their respective positions. In some examples, one or more image sensor(s) 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by a respective eye tracking camera/illumination source(s).

Electronic device 201 is not limited to the components and configuration of FIG. 2, but can include fewer, other, or additional components in multiple configurations. In some examples, device 201 can be implemented between two electronic devices (e.g., as a system). A person or persons using electronic device 201, is optionally referred to herein as a user or users of the device.

Virtual scenes can be used as a digital backdrop when creating cinematic experiences, such as backgrounds for chroma key compositing and/or display on light emitting diode (LED) wall arrays. Virtual scenes can also be included in immersive virtual content, such as immersive virtual scenes for virtual reality (VR), extended reality (XR), and/or mixed reality (MR) applications in which virtual assets consume at least a portion of a view of a viewer's physical environment. Editing virtual scenes, especially when the editing process is collaborative, can be cumbersome and unintuitive using conventional approaches. The present disclosure contemplates methods and systems for improving efficiency of user interaction with virtual assets included in the scene, such as placement of annotations indicating virtual assets that can be added, deleted, edited, or are otherwise of interest to editors of the virtual scene. One or more of the examples of the disclosure are directed to inserting spatial annotations (e.g., annotations having a simulated position relative to the virtual scene, similar to placement of a physical object within a physical environment) drawing user attention toward the annotation, and facilitating communication between individuals that are concurrently reviewing or asynchronously reviewing the virtual scene and/or annotations associated with the virtual scene. In one or more examples, a device facilitating the annotation can communicate with one or more other devices, and users of the respective devices can insert respective annotations into the scene and/or inspect annotations placed by other users of other devices. In one or more examples, the device can determine a context of a user of the device to intelligently place annotations within the virtual scene. In one or more examples, the device can intelligently select between one or more categories of user annotation that will be inserted into the virtual scene.

Attention is now directed towards methods and systems of facilitating annotation of a virtual scene displayed in a three-dimensional environment presented at an electronic device (e.g., corresponding to electronic device 201). As described previously, it can be appreciated that extended reality (XR) editing of virtual scenes improves efficiency of user interaction when editing, annotating, and reviewing annotations related to the virtual scenes. Further, it can be appreciated that engaging a plurality of devices in a communication session to collaboratively edit and/or annotate a virtual scene improves clarity and efficiency of communication between the users of the device. The present disclosure contemplates examples of methods and systems of editing and/or annotating a virtual scene, thus improving human-computer interaction when synthesizing the virtual scene.

For example, an electronic device can display a virtual scene that entirely replaces a view of the physical environment, as though the user were physically within a physical equivalent of the virtual scene. In some examples, display of the virtual scene replacing the view of the user's physical environment can correspond to displaying the virtual scene with a level of immersion greater than a threshold level of immersion, the level(s) of immersion described further herein. In some examples, the virtual scene can only partially replace the view of the physical environment, such that a portion of the user's physical environment remains visible to the user, and/or can be displayed with a level of immersion (e.g., opacity) that is less than the threshold level of immersion. In some examples, in response to detecting a change in the user's viewpoint (e.g., changes to the user's position and/or orientation) in the physical environment, the electronic device can change the perspective view of the virtual scene, as though the user were changing positions within the virtual scene. In some examples, a user input such as a gaze, a gesture, or a hand movement can be detected along with a context of that user input, and a corresponding virtual annotation such as a textual note, a voice recording, a simulated marking, and/or relevant media can be added to the virtual scene.

It can be appreciated that the placement of annotations in the virtual scene and/or the appearance of those annotations can be determined in accordance with characteristics of the user input. For example, in response to detecting an air gesture performed by a hand, the electronic device can display a positional indicator pointing toward and/or otherwise emphasizing a portion of the virtual scene. In another example, in response to detecting user input, the electronic device can determine a context between the user and/or their input and the three-dimensional environment. For instance, in response to detecting speech of the user, the electronic device can determine a likely target (e.g., a particular virtual object, a portion of the virtual scene, and/or some combination thereof) in view of the remarks included in the speech using one or more natural language processing methods (e.g., algorithms, machine learning techniques, and/or predefined behaviors dictating annotation placement in the absence of a likely target), and display an annotation at a position corresponding to the likely target.

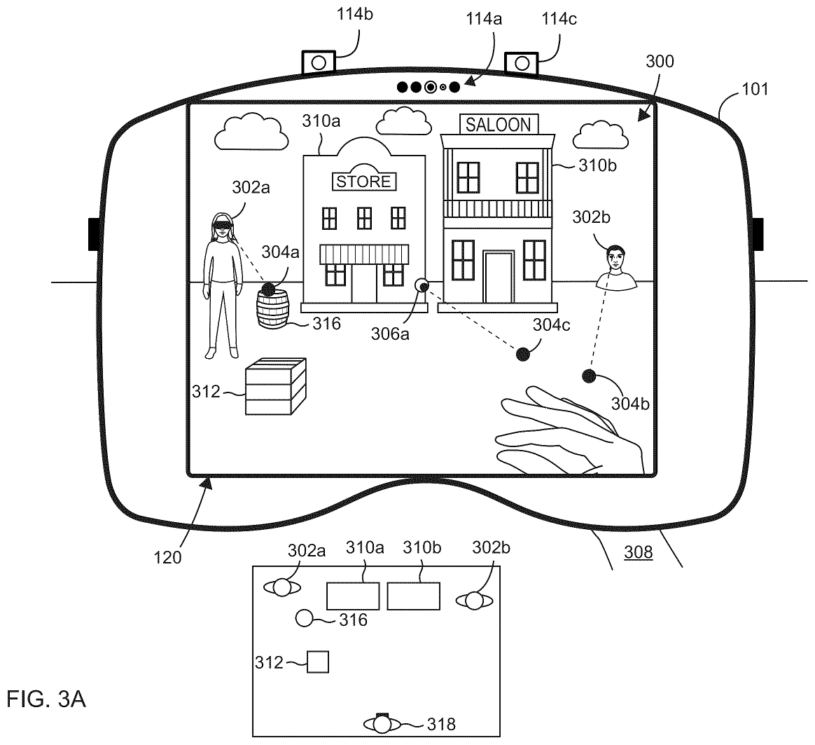

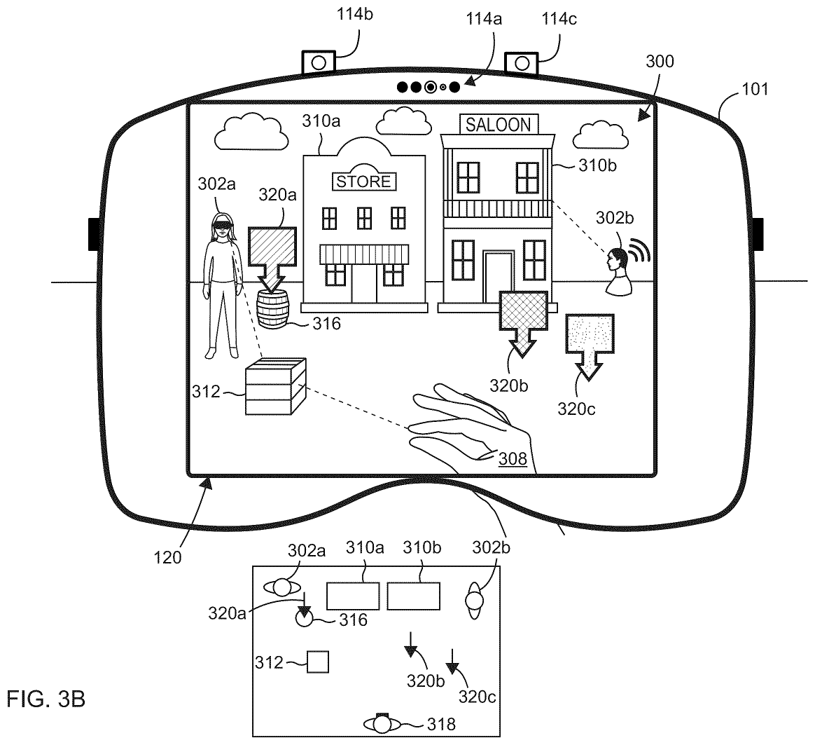

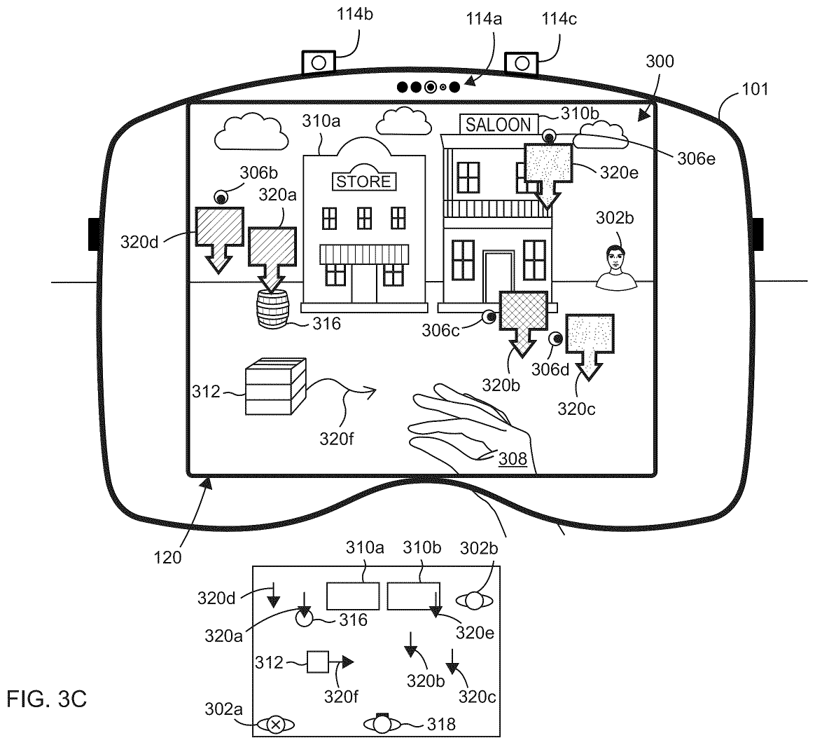

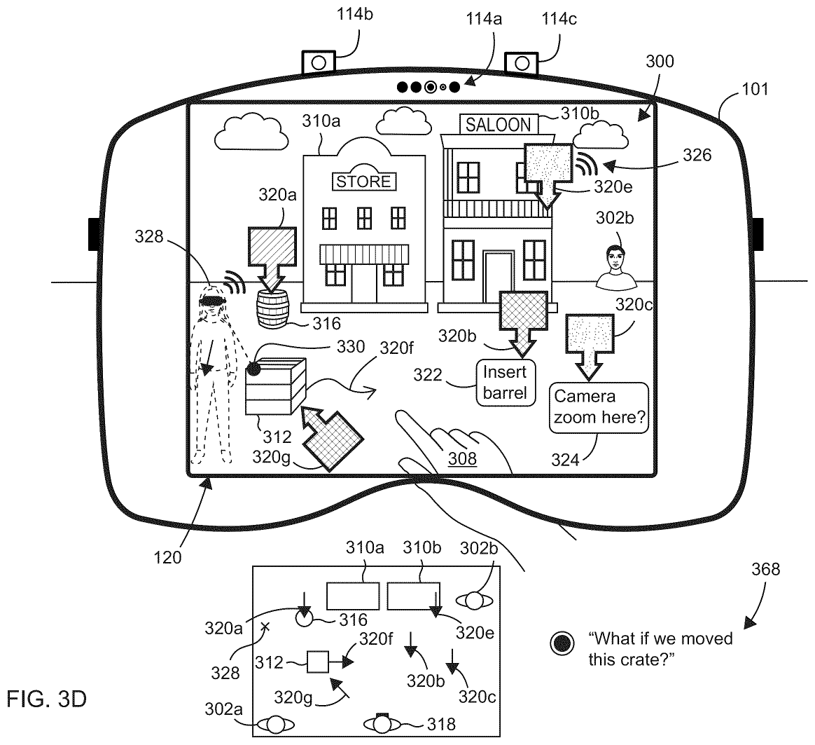

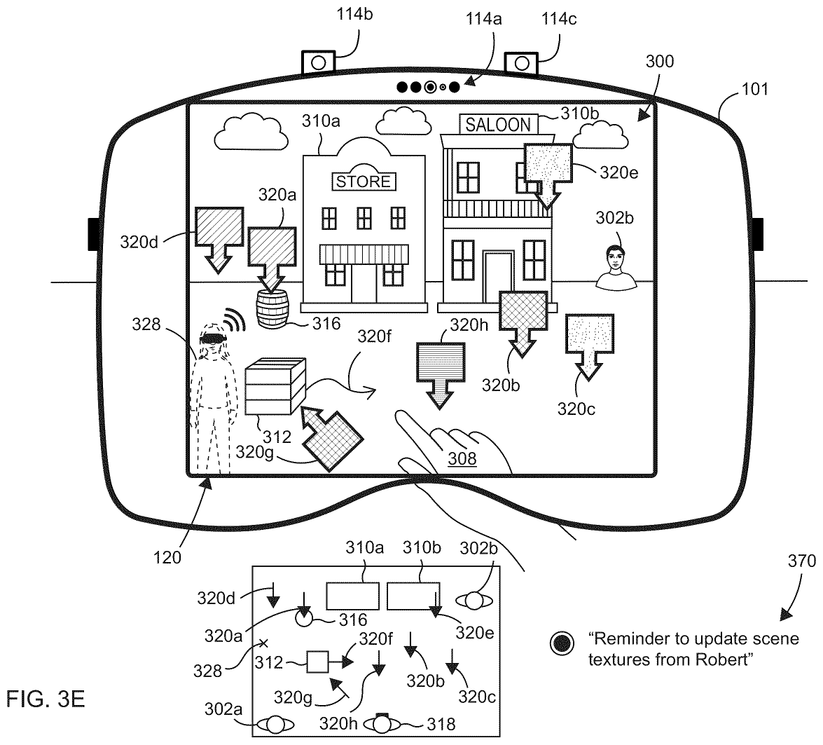

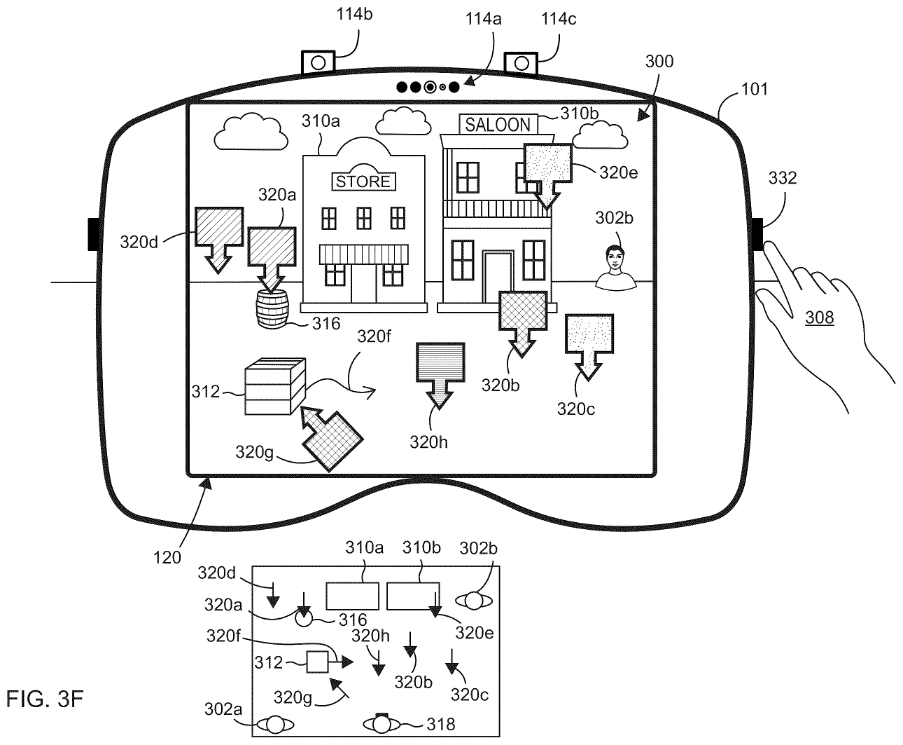

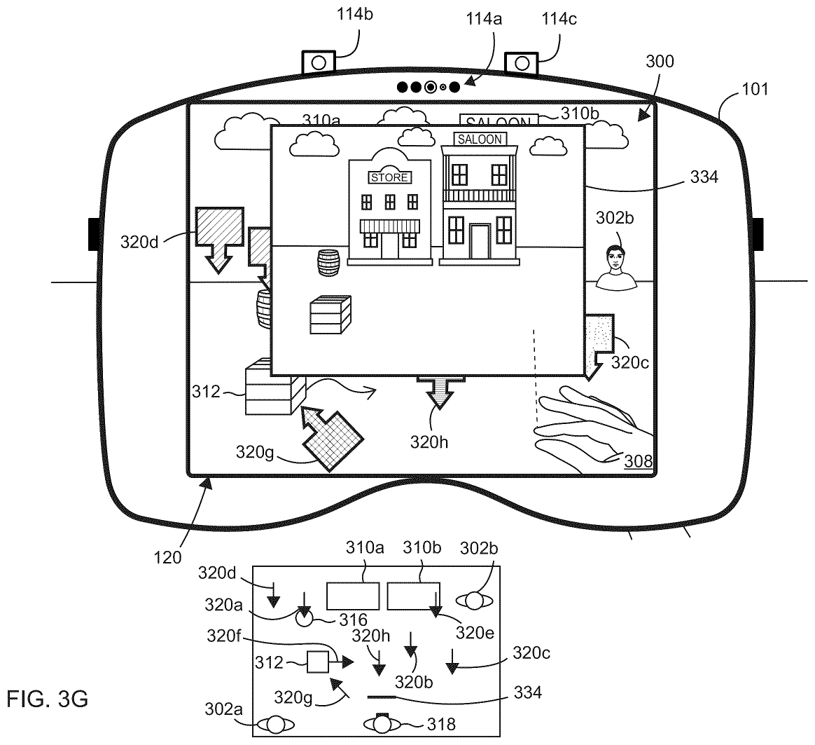

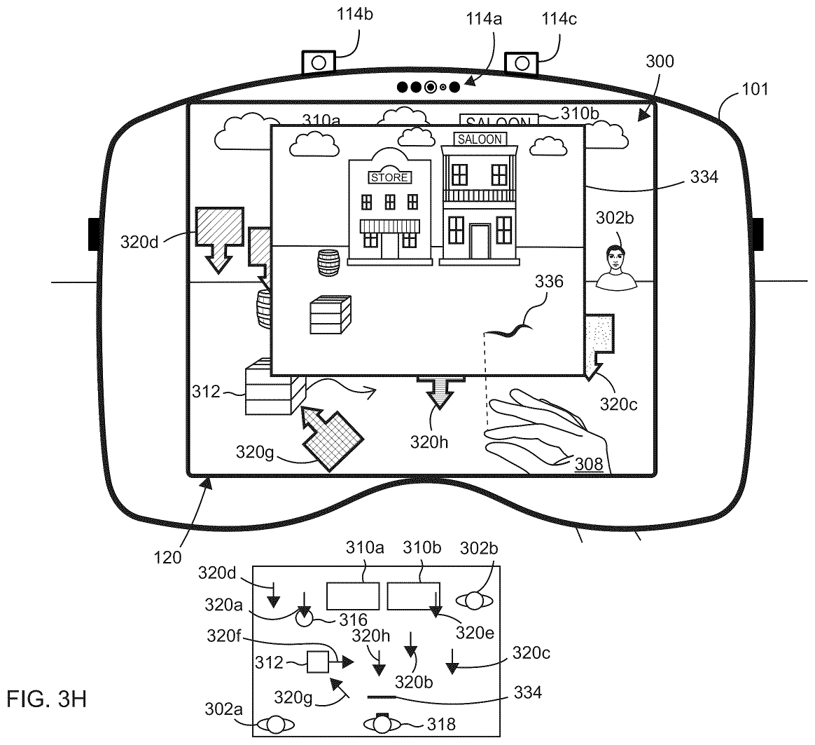

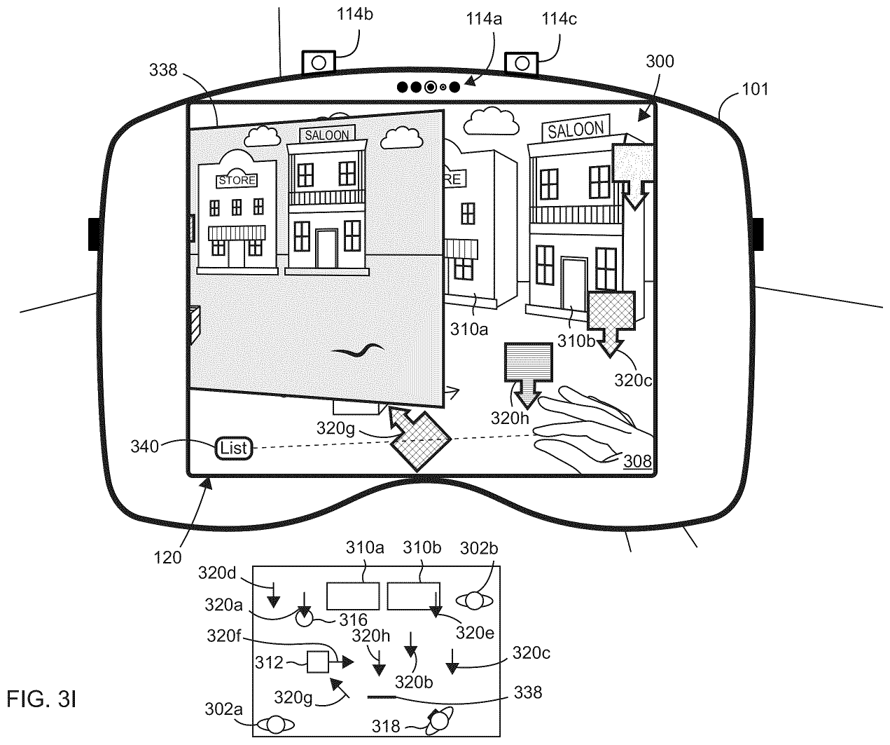

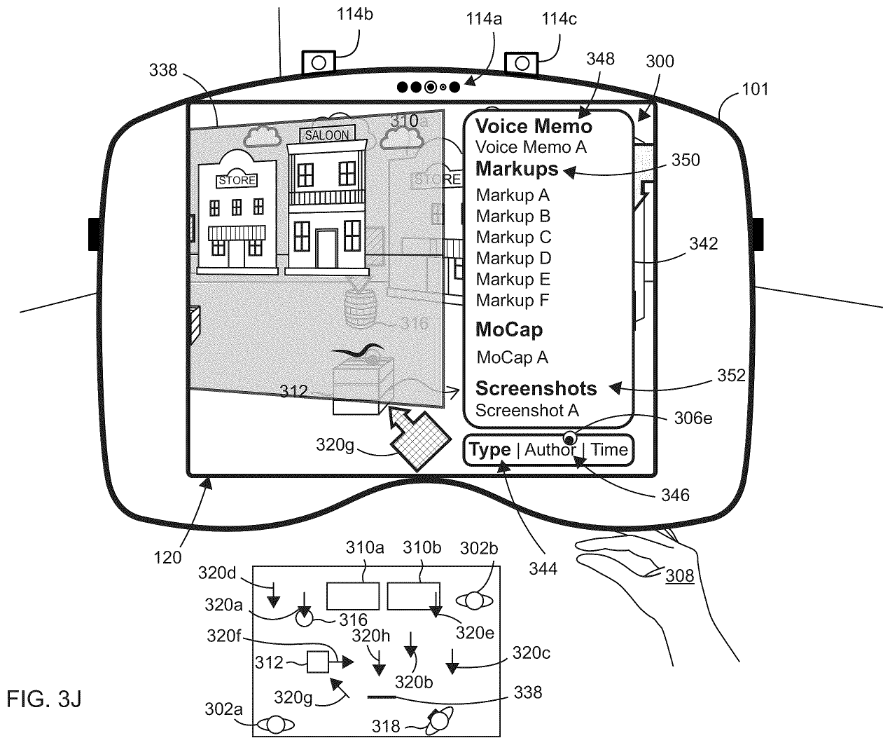

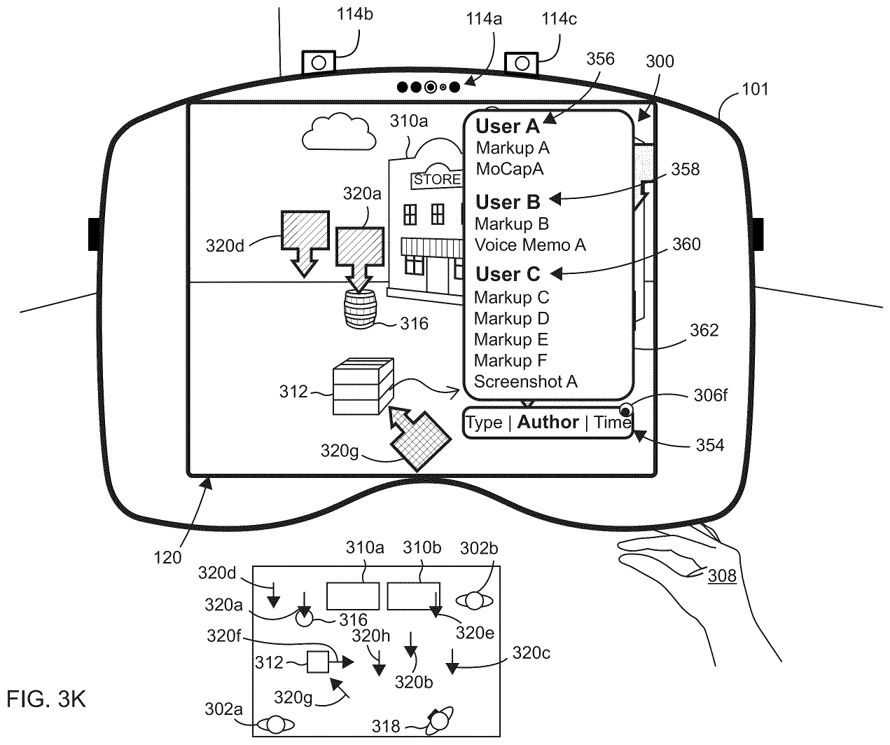

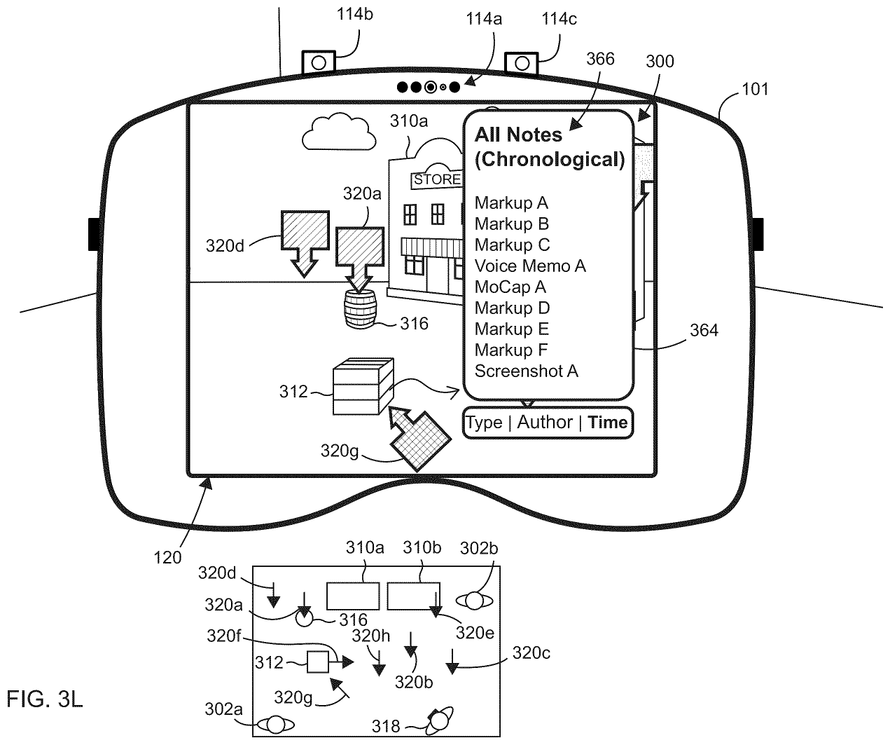

FIGS. 3A-3L illustrate example interactions including annotation, editing, and inspection of a virtual scene in accordance with examples of the disclosure. It can be appreciated that the particular order of inputs, determinations, presentation of information, and other operations described with respect to FIGS. 3A-3L are merely exemplary, and that examples in which the order of execution of such operations can be different from as explicitly described are also contemplated, without departing from the scope of the present disclosure.

The discussion of examples that follow initially will focus on inputs, “user context,” and/or operations performed from the perspective of a user of an electronic device in accordance with examples illustrated in FIGS. 3A-3F. Further examples of the disclosure focus on similar inputs, user contexts, and/or operations performed at other electronic devices participating in a communication session with the electronic device of the user—also accordance with examples illustrated in FIGS. 3A-3F—and operations performed by the electronic device of the user in response to obtaining information from the other electronic devices. The disclosure herein further includes description of virtual “screenshots” in accordance with examples illustrated in FIGS. 3F-3H, and description of user interfaces for viewing annotations associated with a virtual scene in accordance with examples illustrated in FIGS. 3H-3L. It is understood that that the operations performed at the electronic device of the user can be performed at the other electronic devices, and vice-versa.

Turning back to FIG. 3A, an example device visually indicating targets of annotations in accordance with some examples of the disclosure is illustrated. In FIG. 3A, three-dimensional environment 300 includes a plurality of virtual objects and/or textures included in a virtual scene displayed via display 120 of electronic device 101, in addition to a view of the user's physical environment. In FIGS. 3A-3L, three-dimensional environment 300 is illustrated from the perspective of the electronic device 101, and additionally from an overhead perspective in a glyph below the perspective of electronic device 101. In some examples, the virtual scene is an immersive three-dimensional environment. For example, a user of electronic device 101 is able to physically move throughout their physical environment (including areas of the physical environment located beyond the extremities of a housing of electronic device 101 in FIG. 3A), and device 101 optionally updates a simulated perspective of a virtual sky, virtual floor, objects in response to detecting changes of the user's viewpoint (e.g., the user's position and/or orientation relative to their physical environment), similar to a physical perspective of a physical sky, physical floor, and/or one or more physical objects as the user moves relative to their physical environment. In some examples, the virtual scene included in three-dimensional environment 300 optionally includes a simulated texture overlaying a physical representation of the floor of the user's physical environment, and/or a virtual floor having a simulated spatial profile (e.g., topography) that is different from that of the user's physical environment. Further, the virtual scene can include a simulated atmosphere, such as a virtual sky (e.g., simulating the lower atmosphere at dawn, daylight hours, dusk, nighttime hours, and the like). It is understood that the virtual scene can be any suitable computer generated environment without departing from the scope of the disclosure.

In some examples, the virtual scene is displayed relative to the user's physical environment. The physical environment—visible outside of a housing of electronic device 101—can include a physical room that the user 318 occupies. In some examples, the virtual scene can be displayed within display 120 at least partially replacing a view of a representation of the user's physical environment, thus “consuming” a view of the physical environment. For example, electronic device 101 can include one or more outward facing cameras that obtain images of the user's physical environment, and the images can be displayed via display 120 as if the user were able to view the physical environment directly, without the assistance of electronic device 101. At least a portion or all of such a view of the physical environment can be displayed at corresponding positions of display 120 and with a level of opacity less than a threshold level (e.g., 0, 1, 5, 10, 15, 20, 25, 30, 35, 40, 45, or 50% opacity), and the virtual scene can be displayed at those corresponding positions with a level of opacity greater than a threshold level of opacity (e.g., 0, 1, 5, 15, 25, 40, 50, 60, 65, 75, 90, or 100% opacity). In some examples, the physical environment can include one or more physical objects in the user's environment, physical individuals in the user's environment, physical walls, a physical floor, and the like. In some examples, representations of the user's physical environment can be displayed. For example, the virtual screen included in three-dimensional environment 300 in FIG. 3A can be displayed with an at least partial degree of translucency, overlaying a representation of the user's physical environment (e.g., images collected by sensors 114a-c of the user's physical environment) displayed via display 120. In some examples, a representation of the user's physical environment includes one or more images of the user's physical environment. In some examples, the electronic device 101 displays a real-time, or nearly real-time stream of images (e.g., video) of one or more portions of the physical environment corresponding to a “representation” of the user's physical environment.

As described previously, the virtual scene can include one or more virtual objects in some examples of the disclosure. The virtual objects can include digital assets modeling physical objects, virtual placeholder objects (e.g., polygons, prisms, and/or simulated two or three-dimensional shapes), virtual objects including user interfaces for applications (e.g., stored in memory by electronic device 101), and/or other virtual objects that can be displayed within a VR, XR, and/or MR environment. As an example, three-dimensional environment 300 includes barrel 316, which optionally is a virtual asset displayed within the virtual scene at a simulated position similar to a physical position and orientation of a physical barrel relative to a viewpoint of user 318. Similarly, crate 312 is included in three-dimensional environment, at a different simulated position and/or orientation than the position of barrel 316. In FIG. 3A, building 310a and building 310b are also included in the virtual scene, which are also virtual assets (e.g., virtual buildings) having positions and orientations relative to the virtual scene and/or the viewpoint of user 318. It is understood that greater, fewer, and/or alternative virtual objects can be displayed without departing from the scope of the disclosure.

In some examples, electronic device 101 displays one or more representations of individuals other than user 318 via display 120. For example, representations 302a and 302b are included in three-dimensional environment 300 in FIG. 3A, representative of other individuals that are virtually or physically included in the user's three-dimensional environment 300. As an example, representations 302a and/or 302b optionally are expressive avatars, such as anthropomorphic avatars, having one or more body parts that can move relative to each other. The body parts optionally include a head, hand(s), arm(s), shoulder(s), a neck, leg(s), finger(s), toe(s), facial features, and the like. In some examples, the representations 302a and/or 302b can be individuals that share the user's physical environment, such as individuals that are in the user's physical room. Representation 302a as illustrated includes a plurality of body parts, as an example of a fully expressive avatar or a representation of a physical individual sharing the user's 318 physical environment. Representation 302b as illustrated in FIG. 3A includes a partially expressive avatar or representation of a user of a computer system that is not physically sharing the physical environment of user 318. It is understood that such representations are merely exemplary, and that additional or alternative representations of users of corresponding computer systems can be included in three-dimensional environment 300, and that representation 302a can have one or more characteristics similar to or the same as those described with reference to representation 302b, and vice-versa.

In some examples, the representations 302a and/or 302b can be individuals that are not in the user's physical environment but are represented using spatial information. In some examples, electronic device 101 uses the spatial information to map portions of the physical environment of user 318 to portions of the virtual scene, and/or to map portions of the physical environments of representations 302a and/or 302b to the portions of the virtual scene. As an example, a communication session between electronic device 101, a first computer system used by representation 302a, and a second computer system used by representation 302b can be ongoing to facilitate the mapping between physical environments of respective users of respective computer systems. In some examples, the communication session includes communication of information corresponding to real-time, or nearly real-time communication of sounds detected by the computer systems (e.g., speech, sounds made by users, and/or ambient sounds). In some examples, the communication session includes communication of information corresponding to real-time, or nearly real-time movement and/or requests for movement of representations (e.g., avatars) corresponding to users participating in the communication session.

For example, the first computer system can detect movement of a user corresponding to representation 302a in the physical environment of the user (e.g., different from the physical environment of user 318) and can communicate information indicative of that movement with the communication session. Prior to the movement, the first computer system can display the virtual scene relative to a viewpoint of the first computer system (e.g., a position and/or orientation relative to the virtual scene, similar to a physical position and/or orientation of the user relative to a physical equivalent of the virtual scene). In response to the movement (e.g., obtaining information indicative of the movement from the other computer system), the first computer system can update the viewpoint of the user of the first computer system in accordance with the physical movement (e.g., in a direction, and/or by a magnitude of movement) to an updated viewpoint, as though the user of the first computer system were physically moving through a physical equivalent of the virtual scene. It can be appreciated that requests for such movement can be directed to an input device (e.g., a virtual joystick, a trackpad, a physical joystick, a virtual button, a physical button, and/or another suitable control) in addition to or in the alternative to detecting physical movement of the user. Electronic device 101 can receive such information, and in response can move the representation 302a relative to the virtual scene by a magnitude and/or direction of movement that mimics the physical movement of the user of the first computer system relative to a physical equivalent of the virtual scene. It is understood that other computer systems-such as a computer system corresponding to representation 302b and/or electronic device 101—can also detect similar inputs described with reference to the first computer system, and cause movement of their corresponding representation within the virtual scene.

In some examples, a device in communication with electronic device 101 can cause display of representations of users, a virtual scene, and/or virtual annotations. For example, electronic device 101 can display a virtual annotation received from a computer system other than electronic device 101, such as a desktop or laptop computer. In some examples, the computer system can display a view of the virtual scene, such as a representation of the virtual scene on a planar display. In some examples, the computer system can detect input requesting entry of an annotation directed toward the virtual scene, and can communicate an indication of the input to electronic device 101. In response to receiving the input, electronic device 101 can display a virtual annotation within three-dimensional environment 300 and/or within the virtual scene at a location within the virtual scene that corresponds to (e.g., is the same as) the location indicated in the input. Thus, electronic device 101 and the computer system can synchronize annotations within the virtual scene. Both devices can place annotations in the virtual scene, and/or can display indications of received annotations based on indications received from the other device. It is understood that some or all of the operations described herein with reference to electronic device 101 detecting input for, displaying representations of, and/or recording content for virtual annotations can be performed at the computer system, and that electronic device 101 can synchronize placement of the virtual annotations provided by the computer system with annotations inserted locally to electronic device 101 (e.g., in real-time, or nearly real-time).

It is also understood that movement and/or placement of representations of users participating in the communication session can be defined relative to a shared coordinate system, rather than strictly relative to virtual dimensions of the virtual scene. For example, the electronic device 101 can present a view of the physical environment of user 318 not including a virtual scene, and can display representations at positions within the view of the physical environment and/or movement of the representations within the view of the physical environment. It is understood that the examples described with respect to FIGS. 3A-3L can occur during a communication session (described herein), and that information communicating positions, orientations, audio, and/or other aspects of physical users and/or information provided by physical users can be exchanged via the communication session to devices participating in the communication session. It is understood that dependent upon context, the operations described with reference to virtual content being displayed relative to the virtual scene can be displayed relative to a representation of the user's physical environment, such as visual indications of attention of the user 318 described below.

In some examples, electronic device 101 displays one or more visual indications indicating user attention within three-dimensional environment 300. For example, electronic device 101 detects a virtual position of a target of the user's attention 306a (e.g., gaze), and displays a visual indication 304c at the virtual position, thus presenting a visual indication of the portion of three-dimensional environment 300 that the user's attention is directed to. In some examples, the target of the user's attention is indicated using one or more portions of the user's body other than the eyes. For example, although not shown in FIG. 3A, electronic device 101 can detect a spatial relationship between a point of contact between two fingers included in hand 308 (e.g., forming an air pinching gesture) and electronic device 101. The spatial relationship can be based upon a ray cast (not shown) from a portion of electronic device 101, such as a center of electronic device 101, through the portions of the user's body (e.g., through the air pinch gesture), and extending toward a position within the virtual scene. In some examples, the virtual scene has a simulated depth, and the visual indication 304c is displayed at a position in accordance with the user's attention and/or the spatial relationship between the device 101 and the air gesture. As an example, electronic device 101 in FIG. 3A displays visual indication 304c at a position on a surface of the virtual floor included in the virtual scene due to the user's gaze, and/or the ray projected from device 101 through the air pinch gesture intersecting with the position on the virtual floor.

In some examples, electronic device 101 can display indications of attention of the other users. For example, in FIG. 3A, attention (e.g., gaze) of a user corresponding to representation 302a is directed to barrel 316. The computer system of that user can detect that barrel 316 is the target of the user's attention, and can communicate information indicative of that target to electronic device 101. In response to obtaining the information, electronic device 101 can display a visual indication of attention, such as visual indication 304a in FIG. 3A. Similarly, a computer system corresponding to representation 302b can detect attention of a user corresponding to representation 302b, and can display a visual indication of the user's attention such as visual indication 304b in FIG. 3A. It is understood that in some examples, in response to detecting information that the attention of a corresponding user has changed relative to the three-dimensional environment 300 and/or the virtual scene, corresponding electronic devices can communicate information moving the attention indicative of an updated target of attention. In response to obtaining such updated information, electronic device 101 can move the visual indication of attention (e.g., move visual indication 304a and/or visual indication 304b) in accordance with the updated information to an updated position and/or orientation relative to content included in the virtual scene.

In some examples, electronic device 101 displays one or more visual indications of attention illustrating an aggregation of one or more targets of the attention over time. For example, electronic device 101 can display a heatmap indicative of a location of the attention over a period of time (e.g., 1, 3, 5, 10, 15, 30, or 60 seconds, and/or over a period of time that a user is speaking and/or pointing finger(s) toward three-dimensional environment 300). Electronic device 101 can display the heatmap which can encode duration of the attention using a gradient of colors and/or levels of saturation. For example, a dark red portion of the heatmap overlaying the three-dimensional environment 300 can indicate that attention was directed to the corresponding first portion of the three-dimensional environment 300. A dark blue portion of the heatmap can indicate that attention was directed to a corresponding second portion of three-dimensional environment 300 for relatively less time than was directed to the first portion of three-dimensional environment 300. In some examples, intermediate shades of light blue, light red, and additional or alternative colors can indicate that attention was directed to corresponding one or more portions of three-dimensional environment 300 for respective periods of time greater than the dark blue portion and/or less than the dark red portion. It can be appreciated that electronic device 101 can implement the heatmap using a range of saturation, opacity, fill patterns, other colors, and/or some combination thereof to indicate duration of attention toward portions of three-dimensional environment 300.

In some examples, electronic device 101 selectively displays the visual indication of attention (e.g., visual indication 304c in FIG. 3A). For example, when an interaction mode relative to the virtual scene is enabled (e.g., an editing mode), electronic device 101 can display the visual indication of attention. In some examples, when the interaction mode is disabled, the electronic device forgoes display of the visual indication of attention. Similarly, while the interaction mode is enabled, electronic device 101 can display other visual indications of attention of other users, and while the interaction mode is disabled, the electronic device 101 can forgo display of the visual indications of attention of the other users. In some examples, electronic device 101 displays the visual indication(s) of attention in accordance with user preference. For example, a user setting specified by electronic device 101 can permit or prohibit sharing of visual indications of attention of user 318 with other users participating in a communication session with electronic device 101. In some examples, the visual indication of attention can be displayed in response to detecting an express request to display the visual indication (e.g., a predefined air gesture performed by the user's body, a pose of one or more portions of the user's body, a verbal request to display the visual indication, and/or selection of a virtual and/or physical control (e.g., button, slider, and/or menu options)) within three-dimensional environment 300 and/or to share the visual indication with other devices participating in the communication session with electronic device 101.

As an additional example, in FIG. 3B, attention of representation 302a is directed to a portion of crate 312 that is not visible at the viewpoint of user 318. In accordance with a determination that attention of a user is directed to a portion of the virtual scene that is not visible (e.g., as though a physical user is gazing at a portion of a physical crate that the user 318 could not see from their perspective), electronic device 101 forgoes display of a representation of attention of representation 302a. Additionally or alternatively, electronic device 101 can display a visual indication of attention with a modified appearance (e.g., a different spatial profile such as a simulated glow surrounding a portion of crate 312, an arrow with a simulated depth curving behind crate 312, and/or with visual characteristics (e.g., opacity, blurring, saturation, and/or a simulated lighting effect)) to convey that a target of attention of the user is not currently visible to user 318. It is understood that the visual indications of attention can be displayed, and are at times omitted from the figures for convenience. For example, a visual indication of representation 302b in FIG. 3B directed to building 310b can be displayed.

In some examples, electronic device 101 detects one or more user inputs associated with requesting display of virtual annotations. In some examples, the one or more user inputs optionally include an air pinching of fingers of hand 308 as shown in FIG. 3A. In some examples, the one or more user inputs include movement of one or more portions of the user's body. For example, from FIG. 3B to FIG. 3C, the one or more user inputs include movement of hand 308 relative to a viewpoint of the user and/or relative to electronic device 101. As described with reference to FIG. 2, electronic device 101 includes and/or communicates one or more sensors to detect a spatial relationship between the user's viewpoint, the one or more portions of the user's body, and the virtual scene. For example, electronic device 101 optionally casts one or more rays from the one or more sensors, intersecting with the one or more portions of the user's body, and further intersecting with one or more portions of the virtual scene. In some examples, electronic device 101 detects that user input is being directed to one or more portions of the virtual scene in accordance with a determination that the one or more rays correspond to (e.g., virtually intersect with) the one or more portions of the virtual scene. In some examples, the one or more portions of the user's body include one or more fingers, portion of the fingers, palms, hands, wrists, forearms, and/or arms of the user. In some examples, electronic device detects and/or determines a position and/or orientation of a plurality of the aforementioned one or more body parts, and determines a target of user input in accordance with a combination of the positions and/or orientations of the plurality of one or more body parts.

In some examples, the one or more user inputs include attention of the user. For example, electronic device 101 in FIG. 3A detects a position and/or orientation of one or more eyes of the user (e.g., attention 306a) using one or more imaging sensors such as one or more cameras included in sensors 114a-c. In some examples, the electronic device 101 detects a position and/or orientation of one or more rays projected from the one or more eyes of the user to respective one or more positions within three-dimensional environment 300. In some examples, electronic device 101 detects user input to the respective one or more positions that correspond to (e.g., intersect or are near) the one or more rays projected from the one or more eyes of the user.

In some examples, the one or more user inputs include speech of the user. For example, in FIG. 3D, audio 368 is detected by electronic device 101. The audio optionally includes one or more words spoken by the user that are detected by one or more microphones included in and/or in communication with electronic device 101. In some examples, electronic device 101 parses and/or communicates information to one or more external computing devices to determine a content of the user's speech, including identifying the user's words and/or obtaining a semantic understanding of the speech. For example, electronic device includes one or more processors that are configured to perform natural language processing to detect one or more words and determine a likely meaning of a sequence of the one or more words. In some examples, the electronic device 101 additionally or alternatively determines the meaning of the sequence of the one or more words based upon a determined context of the user. FIG. 3B is further representative, and illustrates an example in which the user corresponding to representation 302b is speaking, as indicated by the curved lines indicative of audio emanating from representation 302b.

In some examples, electronic device 101 determines a context of the user's interaction with three-dimensional environment 300. For example, electronic device 101 determines the user's context—partially or entirely—based upon the position and/or orientation of visual indication 304c when an input is detected. For example, because the user's attention is directed to a position on the virtual floor in FIG. 3A when the air pinch is detected, electronic device 101 displays an annotation 320b at the position illustrated in FIG. 3B in response to detecting the air pinch. In some examples, user context is determined using additional or alternative factors. For example, in the absence of an air pinch gesture including contact between the user's fingers, electronic device 101 can display an annotation at a position corresponding to where the target of attention is directed in response to detecting a user input requesting placement of the annotation. As an example, the audio 368 provided by user 318 in FIG. 3D optionally is parsed by electronic device 101 to determine that user 318 is likely referring to crate 312, because the user references moving “this crate” while crate 312 is the only virtual object resembling a physical crate. Thus, electronic device 101 optionally determines that user context in FIG. 3D corresponds to a “crate” or a crate-like virtual object, and optionally determines that crate 312 corresponds to the crate of interest. Similarly, in FIG. 3C, in response to obtaining information of the speech of the user corresponding to representation 302b in FIG. 3B, electronic device 101 displays annotation 320e at a position oriented toward building 310b, due to the user's attention and/or speech suggestive of the user's context. It is understood that in some examples of the present disclosure, “annotation” and a “representation of an annotation” are used interchangeably.

In some examples, either in response to, concurrently occurring with, and/or after insertion of a representation of an annotation into the virtual scene, electronic device 101 detects and/or prompts user 318 for information corresponding to the annotation. For example, electronic device 101 displays a user interface prompting the user to provide speech, air gesture(s), text entry (e.g., via a virtual or physical keyboard), movement, attention, and/or other suitable modalities of information. Such a user interface can include one or more virtual buttons to initiate text entry, recordings of voice, recordings of movement, and/or recordings of the user's attention, and/or to cease such text entry and/or recordings. After text entry and/or recordings provided by the user 318 are complete, electronic device 101 can cease display of the user interface and/or associate the provided information with a corresponding representation of an annotation. In some examples, electronic device 101 begins recording and/or initiates text entry without display of a dedicated user interface in response to insertion of the representation of the annotation into the virtual scene.

In some examples, after inserting a virtual annotation into the virtual scene, the virtual annotation will be associated with the virtual scene and can be viewed again independently of an ongoing communication session. For example, one or more users can exit the virtual scene, and when again displaying the virtual scene, an electronic device presenting the virtual scene can display annotations inserted during a previous communication session, with or without communication with additional electronic devices.

In some examples, electronic device 101 can map user speech to virtual objects in accordance with a determination that the user speech describes an object that is similar to a virtual object. For example, speech referring to a box, a rectangular prism, a cuboid, a container, a basket (e.g., if the virtual object includes an opening on at least one side of crate 312), and the like can be determined to correspond to crate 312. Additionally, speech referencing a name assigned to crate 312 can be detected (e.g., “crate 1”) and determined to correspond to crate 312. In such example(s), electronic device 101 can interpret the pronoun “this” object as a virtual object that the user 318 directed their attention to within a threshold amount of time (e.g., 0, 0.01, 0.05, 0.1, 0.5, 1, 1.5, 2, 3, 5, 10, or 30 seconds), a physical object that the user physically gestured toward (e.g., pointing at, moving their fingers and/or hands toward, moving their lips toward the virtual object, leaning their head toward the virtual object, moving their arm toward the virtual object, and/or pointing their leg and/or foot toward the virtual object), and/or a virtual object that is within a threshold distance (e.g., 0, 0.01, 0.05, 0.1, 0.5, 1, 1.5, or 3 m) of the user. Similarly, speech referencing a cask, cylinder, drum, barrel, tub, and/or keg can be determined to correspond to barrel 316 in FIG. 3D. It is understood that additional or alternative factors can be contemplated without departing from the scope of the disclosure. For example, speech indicating “that,” “these,” “those,” “the object over there,” and the like can be detected by electronic device 101, and mapped to one or more virtual objects in accordance with determinations of user context.

In some examples, electronic device 101 can determine user context in accordance with movement, indications of attention, and/or other factors. For example, in FIG. 3C, in response to detecting movement, attention, and/or speech of the user corresponding to representation 302a, the computer system corresponding to representation 302a can communicate information indicating the detected movement, attention, and/or speech. In response to detecting that information, the electronic device corresponding representation 302a can initiate a spatial recording, storing and/or capturing information to later present an animation and/or audio recording including the user's movement, speech, and/or indication of attention. In such examples, the recording can be initiated without detecting an express input (e.g., an actuation of a virtual or physical button, a voice command, an air gesture, and/or another suitable input as described further herein) or can be initiated in response to the express input. For example, the electronic device can detect that the user began talking about crate 312, is looking at crate 312, and/or is moving around and/or within a threshold distance of crate 312, and determine that the user's context relates to crate 312. The recording can continue until the electronic device detects a ceasing of speech, a pause in speech, a movement of a distance beyond a threshold distance from crate 312, a change in attention away from crate 312, and/or until an input (e.g., an express input) requesting ceasing of the recording is detected. Information indicative of the recording can be communicated to other computer systems in real-time, after the recording is concluded, and/or in response to the ceasing of the recording. In response to obtaining such information associated with the recording, electronic device 101 can display an annotation such as 320d within the virtual scene, which can later be interacted with as described further herein to initiate presentation of a spatial representation of the user's speech, indication of attention, and/or presentation of audio included in the recording, optionally concurrently.

In some examples, user context can be used to determine a likely target between a plurality of potential targets. For example, user speech indicating “this” building can be detected, and electronic device 101 can be used to determine whether the speech corresponds to building 310a or building 310b in accordance with a determined user context (e.g., described with reference to crate 312). As an example, when such speech is detected, user attention is or was recently directed to building 310a. In response to detecting such speech, electronic device 101 can display a virtual annotation pointing toward building 310a, rather than pointing toward building 310b. Similarly, speech referencing “the saloon” can be detected by electronic device 101, and determined to correspond to building 310b due to a name assigned to building 310b and/or text included in building 310b (“e.g., “SALOON”).

In some examples, user context can be determined to correspond to a plurality of likely targets, and electronic device 101 can display an annotation directed toward the plurality of targets. For example, electronic device 101 can detect speech directed to “these” or “those” buildings while user 318 has a viewpoint as illustrated in FIG. 3D relative to the virtual scene and/or three-dimensional environment 300. In response to detecting that speech, electronic device 101 can determine that building 101a and building 101b are within the viewport of electronic device 101, and can accordingly display an annotation pointing toward building 101a and building 101b and/or visually emphasizing (e.g., display the buildings 101a and 101b with a simulated glow outlining) the virtual buildings. A “viewport” of electronic device 101 is described further herein, and can refer to a virtual viewport that has a viewport boundary defining the extent to which the three-dimensional environment—optionally including portion(s) of the virtual scene—is visible to the user.

In some examples, one or more factors indicative of user context (e.g., speech, air gesture(s), air pose(s), gaze, previous interactions with the three-dimensional environment 300, and the like) can be used in combination to determine a likely set of one or more virtual objects that are a likely target of annotation. The electronic device 101, for example, can use gaze in conjunction with speech, can disregard one or more factors associated with user context (e.g., an air gesture overriding gaze and/or speech), and/or can probabilistically determine user context based on placement (e.g., display) of previous annotations in view of previous determinations of user context.

In some examples, user context can be determined to be generic, and not expressly referencing a virtual object within the three-dimensional environment. For example, FIG. 3E illustrates audio 370 generated by user 318 contemplating a “reminder to update scene textures from Robert.” In such an example, electronic device 101 can determine that the reminder is generally directed to the virtual scene, and does not expressly refer to a particular virtual object. Electronic device 101 can determine that audio 370 generally refers to a plurality of portions of the virtual scene (e.g., scene textures can correspond to a virtual texture overlaying a floor of the virtual scene, one or more textures applied to one or more virtual objects, and/or a virtual texture overlaying a virtual sky included in three-dimensional environment 300). Accordingly, electronic device 101 can display annotation 320h within three-dimensional environment 300 in response to determining the user context is generally directed to the virtual scene. A generically placed annotation such as annotation 320h can be displayed at a predetermined virtual distance (e.g., 0, 0.01, 0.05, 0.1, 0.5, 1, 1.5, or 3 m) of the viewpoint of user 318, such as illustrated in FIG. 3F.

In some examples, user context is determined to be generic and/or directional, such as “to my left,” “to my right,” “in front of me,” and/or in a simulated cardinal direction as specified by user speech. In such examples, electronic device 101 can display a virtual annotation in accordance with a determination of a meaning of the user's speech. For example, electronic device 101 can parse the user's speech, determine a relative portion of three-dimensional environment 300 that the speech can refer to relative to a viewpoint of user 318 when the speech is received, and display and/or place an annotation a predetermined distance from the viewpoint of user 318 toward the relative portion of the three-dimensional environment in response to detecting the speech. For example, discussion of the virtual scene linked to the user's left optionally is mapped to portions of the three-dimensional environment 300 to a left of a center of the user's viewpoint (e.g., including barrel 316 and crate 312 in FIG. 3F). Electronic device 101 can place an annotation (e.g., annotation 320h) at a predetermined distance, and left of the center of the user's viewpoint in response to detecting such discussion. Additionally or alternatively, discussion of the virtual scene linked to the user's right optionally can be mapped to portions of the three-dimensional environment 300 to a right of the center of the user's viewpoint. In response to detecting speech indicating a portion of the virtual scene “to the user's right,” electronic device 101 can place an annotation at the predetermined distance, optionally towards the right of the center of the user's viewpoint. It is understood additional or alternative directions relative to the user's viewpoint and/or simulated cardinal directions can be included as factors in determining user context and/or in placement of the annotations (e.g., behind the user's viewpoint, “north” of the user's viewpoint, and/or above or below what is visible via the viewport while the user 318 has a particular viewpoint).

In some examples, electronic device 101 displays and/or places virtual annotations within the virtual scene based upon the determined user context. For example, in FIG. 3B, electronic device 101 displays annotation 320b within the virtual scene at the position indicated by visual indication 304c in FIG. 3A, corresponding to where the user 318 was gazing toward and/or pointing toward in FIG. 3A. Similarly, electronic device 101 displays annotation 320a in FIG. 3B in response to obtaining information indicating the gaze and/or air gesture target—indicated by visual indication 304a in FIG. 3A—provided by the computer system associated with representation 302a in FIG. 3A. Similarly, electronic device 101 displays annotation 320c in FIG. 3B in response to obtaining information indicating the gaze and/or air gesture target—indicated by visual indication 304b in FIG. 3A—provided by the computer system associated with representation 302b in FIG. 3A. In some examples, in accordance with a determination that information is obtained including a request to insert an annotation at a position in the virtual scene not presently visible to user 318, electronic device 101 presents spatial feedback indicating the position of the requested annotation. For example, the spatial feedback includes audio generated with one or more characteristics to mimic the perception of a physical audio source placed at a physical equivalent of the position of the requested annotation in the user's physical environment playing audio feedback (e.g., a chime, speech, and/or another notification noise). In some examples, the spatial feedback additionally or alternatively includes a visual indication, such as a simulated glowing effect illuminating one or more portions of the user's viewport, the one or more portions close to and/or generally toward the position of the requested annotation.

In some examples, the virtual annotation is displayed in accordance with a target of the user's gaze. For example, in FIG. 3B, representation 302b is gazing toward a second level of building 310b and initiates speech. In FIG. 3C, electronic device 101 displays annotation 302e elevated, near the second level of building 310b based on a determination that the user's context was associated with the second level of building 310b. In some examples, the position of the annotation is expressly indicated by movement of the user. For example, in FIG. 3B, electronic device 101 detects attention and/or an air gesture (e.g., pinch) directed toward a right-face of crate 312, and from FIG. 3B to FIG. 3C detects a path of movement of hand 308 maintaining an air pose by hand 308 of user 318. Accordingly, in FIG. 3C, electronic device 101 displays annotation 320f, the simulated marking described herein, initiated from the right-face of crate 312, following the path of the movement of hand 308, and terminating at a position that corresponds to a projection of a ray between electronic device 101 and hand 308 cast into the virtual scene when the air pinch is released.

In FIG. 3C, annotation 320d is displayed after detecting information indicating that a spatial recording of movement of representation 302a has ceased. The position of annotation 320d in FIG. 3C corresponds to the position of representation 302a when the recording was initiated, but can be other positions such as the position of representation 302a when the recording was terminated and/or a position that is expressly defined (e.g., via a voice command, an air gesture (e.g., an air pinch and movement of the air pinch) moving the annotation 320d, and/or in view of a determined user context, such as a determination that the user's moves are near a virtual object that the representation 302a was talking about, pointing toward, and/or gazing toward).

In some examples, a virtual annotation is displayed at a position in accordance with user context, such as speech. For example, in FIG. 3D, annotation 320g is displayed in response to audio 368 provided by user 318 and detected by electronic device 101. Annotation 320g can be displayed such that the annotation draws the user's attention toward a virtual object and/or portion of the virtual scene associated with the audio 368, such as including an arrow pointing toward and in proximity to crate 312. Similarly, in FIG. 3E, annotation 320h is displayed at the predetermined distance described further herein pointing toward a floor of the virtual scene in response to electronic device 101 detecting audio 370.

In some examples, electronic device 101 determines a position and/or an orientation of the virtual annotations in accordance with a determination of the user's context and/or in accordance with virtual content included the virtual scene. For example, annotations 320a, 320b, 320c, and 320d are displayed pointing downwards toward a virtual object and/or portion of the virtual scene, which optionally can be a default orientation of such annotations. Additionally or alternatively, the annotations can point downward toward the virtual object to further indicate that a particular aspect of the virtual scene is of interest, and/or a particular position on a surface (e.g., virtual floor) included in the virtual scene. Annotation 320f in FIG. 3C, as an additional example, extends from a face of crate 312 in accordance with movement of hand 308 defining that the context associated with annotation 320f relates to an expressly defined path. In some examples, visual properties of the annotation 320f are based upon a currently selected simulated marking implement. For example, the width, color, opacity, and/or additional characteristics of the annotation 320f optionally mimic the appearance of a pen, pencil, brush, chisel-tipped marker, and/or spray paint, when a corresponding simulated marking implement is currently selected. As an example, a visual appearance of annotation 320f can be relatively thicker and/or darker when a chisel-tipped marker was selected when the user 318 generated annotation 320f, as compared to a relatively thinner and/or diffuse appearance of annotation 320f when a simulated pencil was selected. In FIG. 3D, annotation 320g is displayed at an orientation pointing toward crate 312. In some examples, the annotation orientation can be varied based upon surrounding virtual content. For example, in accordance with a determination that annotation 320g would obscure another virtual object, and/or might present a simulated occlusion of another annotation, electronic device 101 can display annotation 320g rotated away from a default orientation and/or translated away from a default position.

Additionally or alternatively, the annotation can lack a precise indication such as an arrow pointing toward a particular position within the virtual scene. In such examples, the annotation can be displayed overlaying, surrounding, and/or extending from a virtual object of interest, the orientation of which can be modified to precisely draw attention toward the portion of the virtual object and/or portion of the virtual scene of interest. For example, in response to detecting speech directed toward a wall included in building 310a, electronic device 101 can display a simulated glowing and/or lighting effect illuminating the wall, extending along one or more dimensions of the wall. Additionally or alternatively, a halo and/or a rounded annotation can be displayed surrounding a base of a virtual object of interest, and/or hovering above a virtual object of interest. It is understood that the spatial profile, visual appearance, position and/or orientation of a representation of an annotation can be the same or different from as described herein, without departing from the scope of the disclosure.

In some examples, a representation of an annotation is displayed with one or more visual characteristics indicating an author of the annotation. For example, in FIG. 3F, a plurality of annotations are displayed within the virtual scene, respectively including a fill pattern corresponding to a particular user such as user 318, a user corresponding to representation 302a, and/or a user corresponding to representation 302b. Additionally or alternatively, the annotations can be displayed with a color, text, an outline, a shape, a size, with a simulated glowing effect, and/or concurrently with an additional visual indication (e.g., with initials, a name, an icon, an electronic communication address, and/or a photograph) separate from an annotation corresponding to an author of the annotations. As an example, annotations 320c and 320e can correspond to representation 302b, and therefore can be displayed with the same fill pattern. Annotations 320a and 320d corresponding to representation 302a can be also displayed with the same fill pattern, for similar reasons. Additionally, annotations 320b and 320g are displayed with the same or similar fill pattern, corresponding to user 318 in FIG. 3F. In some examples, an annotation can be displayed with visual characteristics indicating the genericity of the annotation, and/or to further distinguish such an annotation from other annotations. For example, in FIG. 3E, annotation 320h is displayed with a unique fill pattern due to the user's 318 audio 370 being directed to the virtual scene as a whole, rather than to a particular portion of the virtual scene and/or a virtual object, despite annotation 320h being associated with user 318. In some examples, the visual appearance of representations of annotations are indicative of a type of the annotation. For example, a shape of the annotation, an icon included in the annotation, text included in the annotation and/or displayed nearby the annotation, is optionally dependent upon a corresponding category of the annotation. Speech, for example, is optional representative with an icon including one or more sound waves, in addition to or in the alternative to a pointing indicator drawing attention to a portion of the virtual scene. A spatial recording of movement of a user, as another example, is optionally represented by a screenshot and/or an icon of a representation of the user. It is understood that description of the visual appearance and/or visual characteristics of the annotations described with reference to FIG. 3F is merely exemplary, and can apply to the annotations described with reference to FIGS. 3A-3L.

In some examples, electronic device 101 presents information associated with an annotation in response to detecting user input. In FIG. 3C, for example, a plurality of indications of attention are illustrated that are directed toward various representations of annotations within the virtual scene. It is understood that the user input requesting presentation of the information associated with an annotation can have one or more characteristics similar to or the same as one or more characteristics of other user inputs described herein. For example, attention 306c is directed to annotation 320b, and attention 306d is directed to annotation 320c. In response to detecting such user input, electronic device 101 displays text 322 and text 324 in the virtual scene in FIG. 3D. The text can include text entered using a virtual or physical keyboard, dictation provided by a user requesting entry of such text, and/or simulated handwriting provided via a stylus on a touch-sensitive or non-touch sensitive surface detected by electronic device 101 and/or the stylus.

In some examples, electronic device 101 initiates playback of a recording in response to user input directed toward an annotation. For example, electronic device 101 plays audio 326 in FIG. 3D corresponding to a recording of a voice of the user corresponding to representation 302b in response to detecting attention 306e in FIG. 3C. In some examples, the audio is generated with a simulated spatial quality, as though the audio were emanating from the position of annotation 320e. In some examples, the recording is a spatial recording including a display of movement of a representation of a user. For example, in FIG. 3C, electronic device 101 detects attention directed to annotation 320d. In response to detecting that attention, electronic device 101 can initiate display of a virtual representation corresponding to representation 302a moving throughout the virtual scene, animating the movement of the virtual representation. For example, in FIG. 3D, representation 328 moves from the position of annotation 320d, mimicking the movement of the representation 302a when the recording was captured. In FIG. 3E, representation 328 continues to move throughout the virtual scene, and electronic device 101 displays animations of the corresponding user's movement and gestures.

In FIG. 3D, visual indication 330 is displayed and included in the spatial recording, illustrating the target of the user's attention at the time of recording. Further, in FIG. 3D, audio is generated corresponding to recorded audio provided by representation 302a, and modified (e.g., using one or more filters, digital attenuators, and the like) to present a spatial quality of the audio as though the user corresponding to representation 302a was speaking from its recorded position relative to the virtual scene. It is understood that similar to the change described with reference to the virtual scene, the user's 318 viewpoint can change relative to the three-dimensional environment 300, and the animation can change (e.g., in orientation relative to user 318, and locked relative to the virtual scene) in response to that viewpoint change to emulate the appearance of representation 302a moving and speaking relative to the virtual scene.

In some examples, the appearance of the representation 328 is different from an appearance of representation 302a. For example, the representation 328 can be displayed with a different set of one or more visual characteristics, and/or can be displayed with an avatar having a different spatial profile. As an example, representation 328 can be a wireframe model, animated to convey movement of line-shaped limbs and polygonal appendages, rather than a realistic avatar illustrating details of the user of representation 302a (e.g., facial features, skin tone, musculature, and other characteristics of the user). In some examples, representation 328 has one or more characteristics that are similar or the same as the representation 302a.

Additionally or alternatively, the spatial recording can include display of an animation of the attention of a representation of a user. Attention 306b, for example, can include gaze of the user directed toward annotation 320d, an air gesture (e.g., air pinch) directed toward annotation 320d, a voice command directed toward annotation 320d, and/or another factor determining the target and/or context of the user corresponding to representation 328.

In some examples, electronic device 101 can capture a virtual screenshot of the virtual scene. In FIG. 3F, electronic device 101 detects user input requesting capture of a virtual screenshot. The user input optionally is directed to a mechanical button, circuitry (e.g., a touch-sensitive surface and/or an electromechanical crown button that can rotate and/or be depressed), a voice command, an air gesture performed by the user's hand 308 (e.g., an air pinch, an air pointing of one or more fingers, a closing of one or more fingers into a fist, and/or a splaying of one or more fingers from one another), selection of a virtual button (e.g., via an air gesture), and/or another suitable input. In response to detecting the user input, electronic device 101 can initiate display of a virtual screenshot that captures at least a portion or all of what is visible via the viewport of electronic device 101. In some examples, the virtual screenshot includes strictly/only the virtual scene. In some examples, the virtual screenshot includes representations of the user's physical environment, in addition to or in the alternative to only the virtual scene. In some examples, in response to the user input, an animation is displayed. For example, the entirety of the virtual scene visible via the viewport is optionally captured in response to the user input, and an animation is displayed progressively changing the scaling (e.g., shrinking, and/or maintaining an aspect ratio of the screenshot) until displayed similar to or the same as illustrated in FIG. 3F.

In FIG. 3G, electronic device 101 displays the virtual screenshot in response to detecting the user input in FIG. 3H. For example, in FIG. 3G, electronic device displays screenshot 334 within three-dimensional environment 300. Screenshot 334 is optionally a virtual object, such as a two-dimensional virtual object, and/or a nearly two-dimensional virtual object. For example, a nearly-two dimensional object optionally includes at least two parallel two-dimensional faces, and a simulated depth extending between the parallel two-dimensional faces such that the virtual object can be partially visible when the user's viewpoint is perpendicular to a normal of the two-dimensional faces. In some examples, the screenshot 334 includes or is an image of the portions of the virtual scene that were visible when the user input in FIG. 3H was detected. For example, screenshot 334 includes representations of barrel 316, crate 312, and buildings 310a and 310b, the virtual sky, and the virtual floor included in the virtual scene, and does not include additional virtual objects such as annotations and/or simulated markings visible within the virtual scene, outside of screenshot 334. In some examples, screenshot 334 can include representations of annotations and/or simulated markings that are visible within the virtual scene. In some examples, screenshot 334 is displayed at a predetermined position relative to the viewport of electronic device 101, such as relatively centered within the user's viewpoint, and/or at a predetermined distance from the viewpoint of user 318.

In some examples, electronic device 101 facilitates annotation of the screenshot 334. For example, from FIG. 3G to FIG. 3H, electronic device 101 detects movement of an air gesture, and in response displays annotation 336 overlaying the screenshot 334. In some examples, a visual indication of the user's attention is displayed concurrently with the screenshot 334, overlaying screenshot 334. In some examples, the annotation 336 has one or more characteristics similar to or the same as those described with reference to the annotations displayed within the virtual scene, not included within screenshot 334. Additionally or alternatively, electronic device 101 can detect user context-similar to or the same as those described further herein-associated with and/or directed to screenshot 334, and can display annotations overlaying the screenshot. In some examples, the annotations included in screenshot 334 are not included in the virtual scene, aside from within those included in screenshot 334. In some examples, the annotations included in screenshot 334 are automatically populated within the virtual scene. Thus, electronic device 101 is capable of translating a virtual annotation and/or virtual marking applied to a two-dimensional screenshot 334, and is capable of inserting a similar annotation relative to the virtual scene by spatially determining correspondence between the screenshot 334 and the virtual scene. In some examples, in response to detecting a selection input (e.g., an input similar or the same as those described herein, such as including an air gesture), the electronic device 101 visually distinguishes content included in the screenshot 334, such as displaying an annotation and/or another portion of the screenshot with visual emphasis (e.g., a modified color, level of translucency, simulated glowing effect, saturation, arrow, and/or other positional indicator).

In some examples, electronic device 101 can export the virtual screenshot. For example, the virtual screenshot 334 can be communicated to another electronic device engaged in a communication with electronic device 101, and/or to another device that is similar to or different from electronic device 101. For example, a planar screenshot can be communicated and displayed via a planar display, such as a touchscreen included in a mobile phone, a laptop computer, and/or a head-mounted device capable of displaying immersive virtual content within an at least partially virtual three-dimensional environment.

In some examples, a level of visual prominence of screenshot 334 can change in response to detecting changes in the viewpoint of user 318. For example, from FIG. 3H to FIG. 3I, electronic device 101 detects that the user has rotated radially relative to the screenshot 334, to the position as illustrated in FIG. 3I. In response, electronic device 101 displays screenshot 338 in FIG. 3I, optionally maintaining its position relative to the virtual scene. Electronic device 101 in FIG. 3I can modify one or more visual characteristics of screenshot 338 to convey that the user is relatively off-angle relative to a plane of the screenshot 338. For example, the screenshot can be dimmed, blurred, made transparent, be displayed or not displayed with an outline, and/or desaturated in response to detecting changes in the viewpoint. In some examples, the visual characteristics of screenshot 338 are configured to progressively obscure and/or make the content included in screenshot 338 less visible, and/or make the virtual scene more visible in response to detecting viewpoint changes that increase an angle formed between a vector extending through a center of the user's 318 viewpoint and a vector extending normal to a surface of screenshot 334 and/or 338 in FIGS. 3H and 3I, respectively.

FIG. 3J shows an additional or alternative visual treatment applied to screenshot 338, in which the virtual scene is at least partially visible through screenshot 338. In some examples, in accordance with a determination that the angle between the screenshot and the user's viewpoint exceeds a threshold angle (e.g., 5, 10, 20, 30, 45, 60, 75, or 80 degrees), electronic device 101 ceases display of screenshot 338, or displays a placeholder virtual object such as a border, not including the screenshot. In some examples, the content included in the screenshot 338 is progressively made more or less visible relative to the virtual scene in accordance with similar changes to the screenshot itself.

In some examples, electronic device 101 displays a user interface directed to viewing and interacting with an overview of annotations associated with a virtual scene. For example, in FIG. 3I, electronic device 101 detects input directed to a virtual button, including an air pinch gesture performed by hand 308. In response to detecting that input, electronic device 101 displays user interface 348 in FIG. 3J. In FIG. 3J, user interface 348 includes a listing of annotations present in the virtual scene organized by a category or type of the annotation. For example, in FIG. 3J the user interface 348 includes a sorted listed of voice recordings (e.g., “Voice Memo”), placed annotations and/or simulated markings (e.g., “Markups”), spatial recordings of representations of users (e.g., “MoCap”), and/or virtual screenshots (e.g., “Screenshots”) that have been inserted into the virtual scene. In response to detecting user input (e.g., voice commands, air gestures, attention, contact with a trackpad, and/or selection of a virtual or physical button), electronic device 101 can present information associated with that annotation. For example, as described further herein, electronic device 101 can display text, generate audio, initiate playback of a spatial recording, and/or some combination thereof in response to detecting a selection input of a representation of an annotation included in user interface 348 (e.g., “Voice Memo A,” “Markup A,” “MoCap A,” “Screenshot A,” etc.).

In some examples, in response to selection of a particular representation and/or a plurality of representations, electronic device 101 ceases display of user interface 348 and/or visually emphasizes a corresponding representation of an annotation within the virtual scene, such as annotation 320g in FIG. 3J. Additionally or alternatively, in response to such a selection, electronic device 101 can temporarily cease display of other representations of attention that are not selected to visually focus upon the annotation(s) of interest.

In some examples, a representation of an annotation included in user interface 348 can have one or more visual indications (e.g., icons, visual characteristic(s), fonts, and the like) included in user interface 348 to convey an author of a corresponding annotation, similar to as described with reference to the other virtual annotations herein.

In FIG. 3J, electronic device 101 detects an input directed to a virtual button 306e (e.g., “Author”), corresponding to a virtual button that can change the user interface directed to viewing and interacting with an overview of annotations associated with a virtual scene. In response to the input, electronic device 101 displays user interface 362 in FIG. 3K. User interface 362 includes a similar or same listing of annotations associated with the virtual scene as illustrated in user interface 342, organized by a user who provided the annotation, rather than a category of the annotation. For example, heading 358 (e.g., “User B”) can correspond to representation 302b, and the one or more annotations listed under heading 358 can include annotations that representation 302b inserted into the virtual scene. Similarly, heading 360 (e.g., “User C”) can correspond to user 318, and one or more annotations listed under heading 360 can include annotations that user 318 inserted into the virtual scene.

In FIG. 3K, electronic device 101 detects an input directed to virtual button 306f (e.g., “Time”), corresponding to a virtual button that can display a user interface directed to viewing and interacting with an overview of annotations associated with the virtual scene, organized chronologically. In response to that input, in FIG. 3L, electronic device 101 displays user interface 364. As indicated by heading 366, the listing of annotations in user interface 364 can be organized chronologically (e.g., in forward or reverse chronological order). For example, because “Markup A” corresponding to annotation 320a in FIG. 3B was first-inserted into the virtual scene, “Markup A” is first-listed in user interface 364. In some examples, the user interfaces presenting an overview of annotations of the virtual scene can be displayed differently than as expressly illustrated.

In some examples, the overhead view of the three-dimensional environment and/or of the virtual scene is displayed by electronic device 101. For example, the glyph illustrating three-dimensional environment 300 can be displayed by electronic device 101 in response to detecting a suitable user input requesting display of a user interface and/or virtual object including the glyph. In some examples, the virtual object including the glyph can be displayed, in a manner similar or the same as described with reference to the virtual screenshots herein. In some examples, electronic device 101 can detect input directed to the virtual screenshot, such as a selection of a representation of an annotation, and can present information similar or the same as described with reference to annotations 320a, 320b, 320c, 320d, 320e, 320f, 320g, and/or 320h. For example, electronic device 101 can generate audio from a voice recording, can display text, can display visual indications of attention, and/or can display a movement of a representation of a user throughout the virtual scene, corresponding to a recorded movement of the user, from the overhead perspective. In some examples, the glyph is displayed concurrently with other virtual content, including the virtual scene, one or more virtual screenshots, virtual object(s), representations of annotations, and the like.

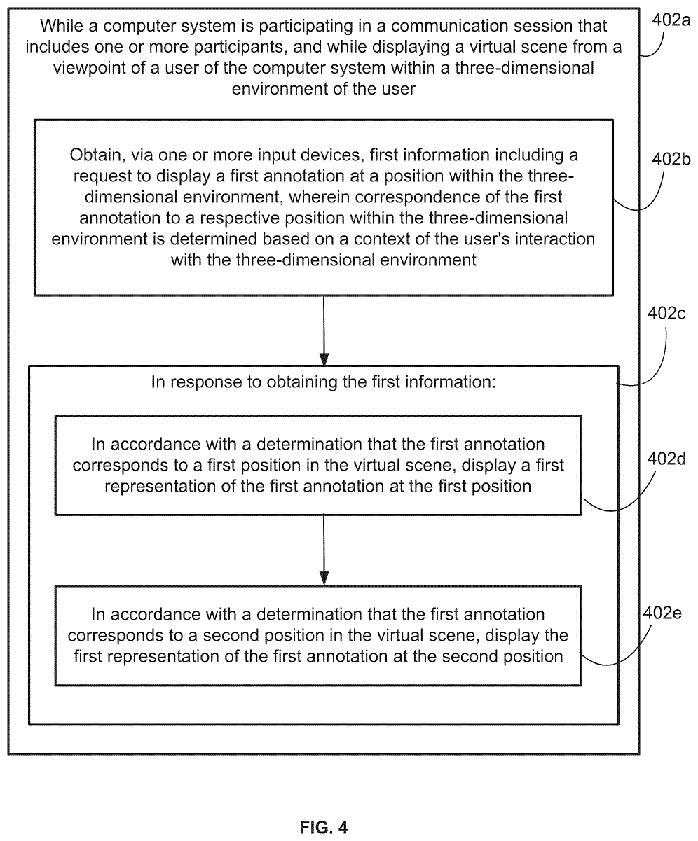

FIG. 4 illustrates a flow diagram illustrating an example process for interactions including annotation, editing, and inspection of a virtual scene in accordance with examples of the disclosure. In FIG. 4, a method 400 can be performed at a computer system in communication with one or more inputs devices and a display generation component. In some examples, while the computer system is participating in a communication session that includes one or more participants, and while displaying a virtual scene from a viewpoint of a user of the computer system within a three-dimensional environment of the user (402a), the computer system obtains (402b), via the one or more input devices, first information including a request to display a first annotation at a position within the three-dimensional environment, wherein correspondence of the first annotation to a respective position within the three-dimensional environment is determined based on a context of the user's interaction with the three-dimensional environment. In some examples, in response to obtaining the first information (402c), and in accordance with a determination that the first annotation corresponds to a first position in the virtual scene, the computer system displays (402d) a first representation of the first annotation at the first position. In some examples, in response to obtaining the first information (402c), and in accordance with a determination that the first annotation corresponds to a second position in the virtual scene, the computer system displays (402e) the first annotation at the second position.

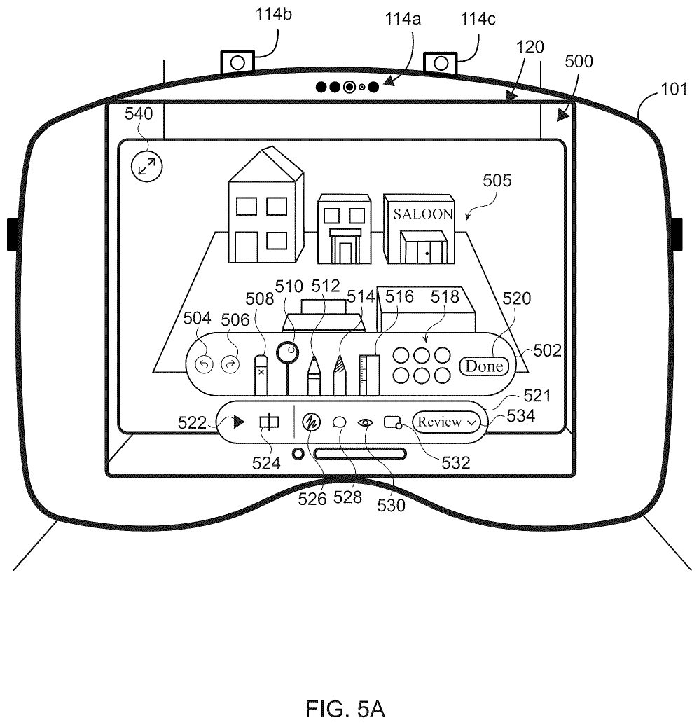

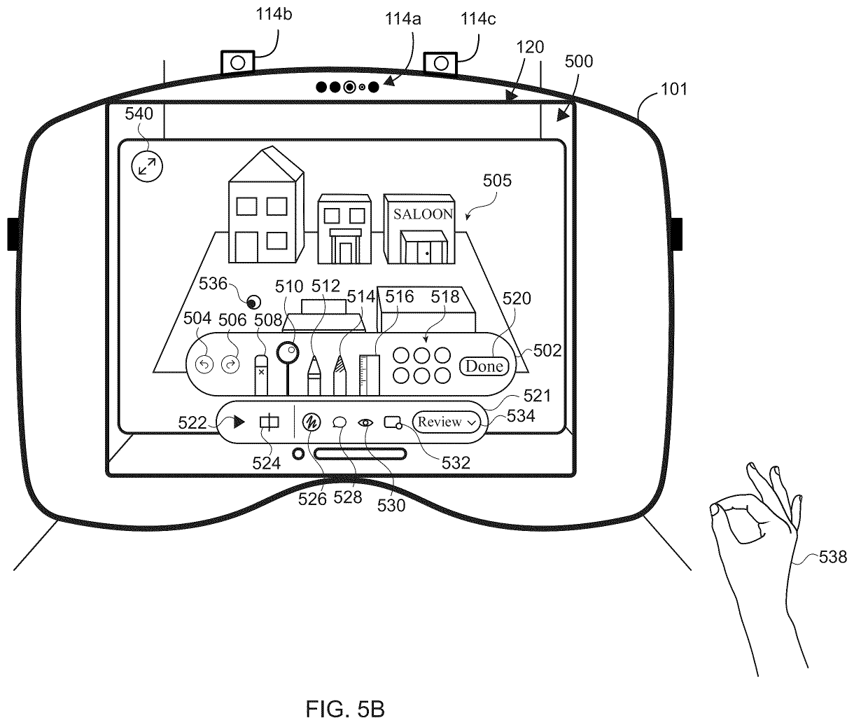

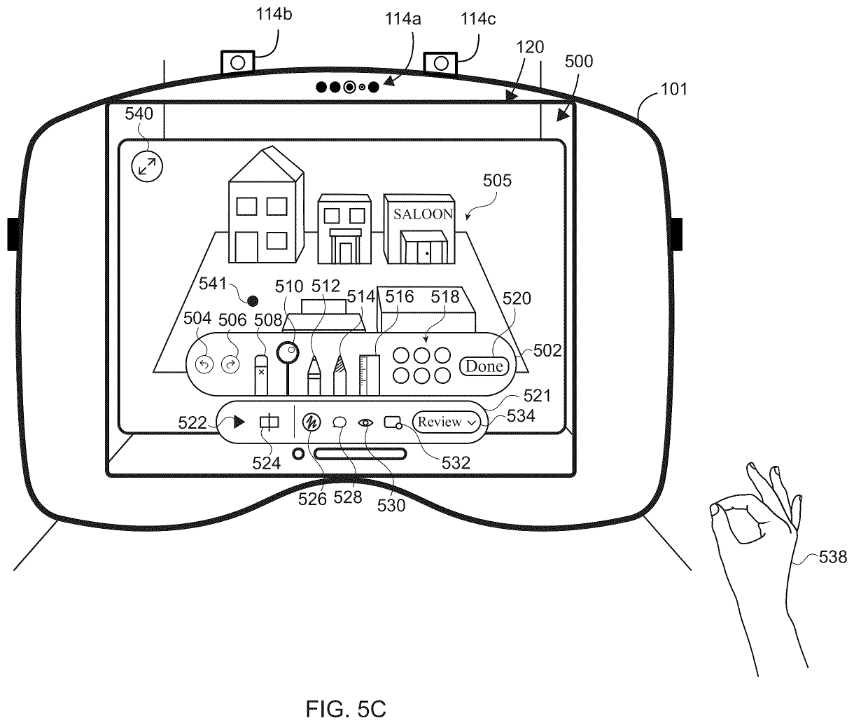

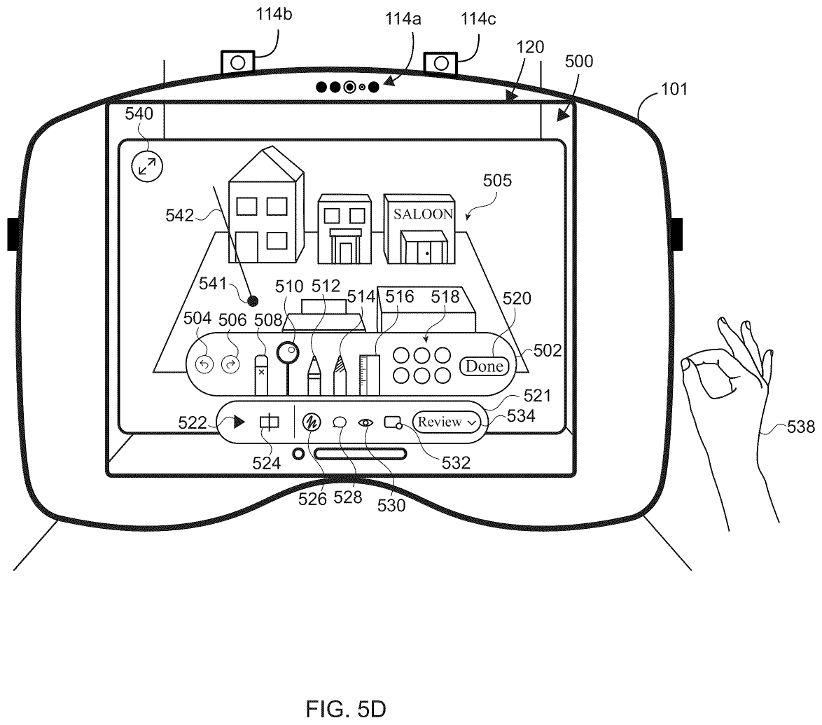

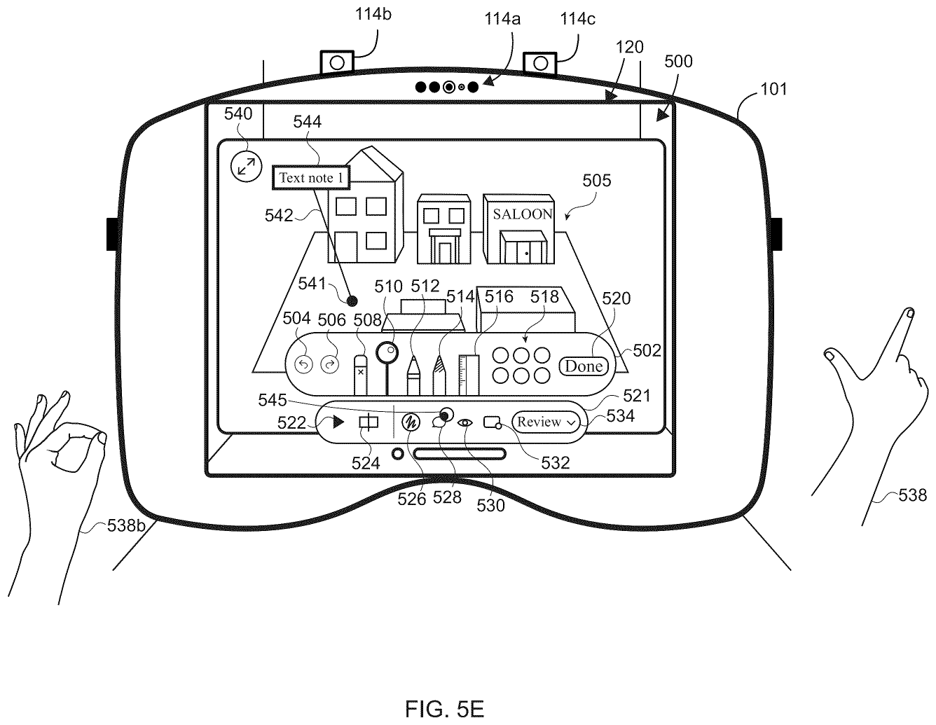

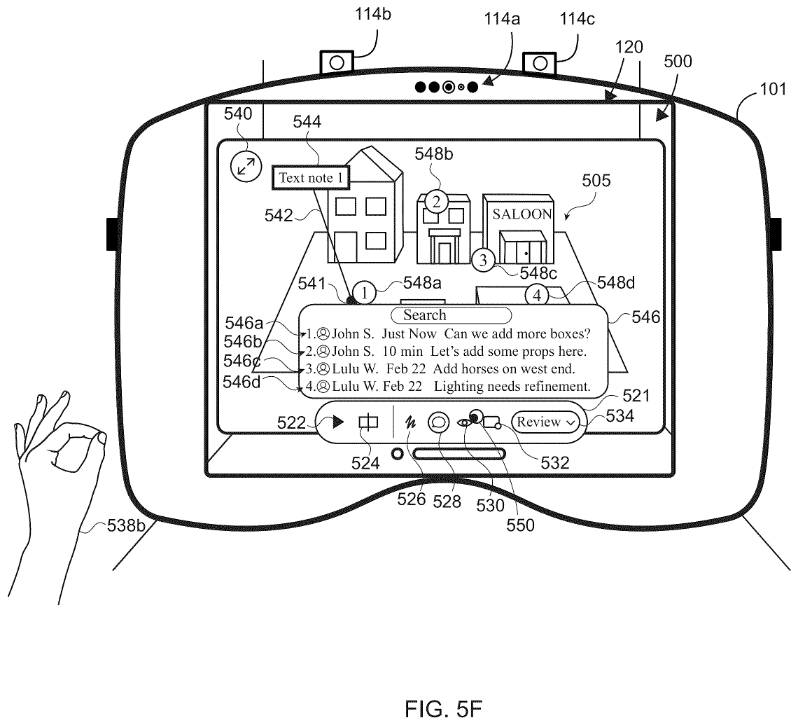

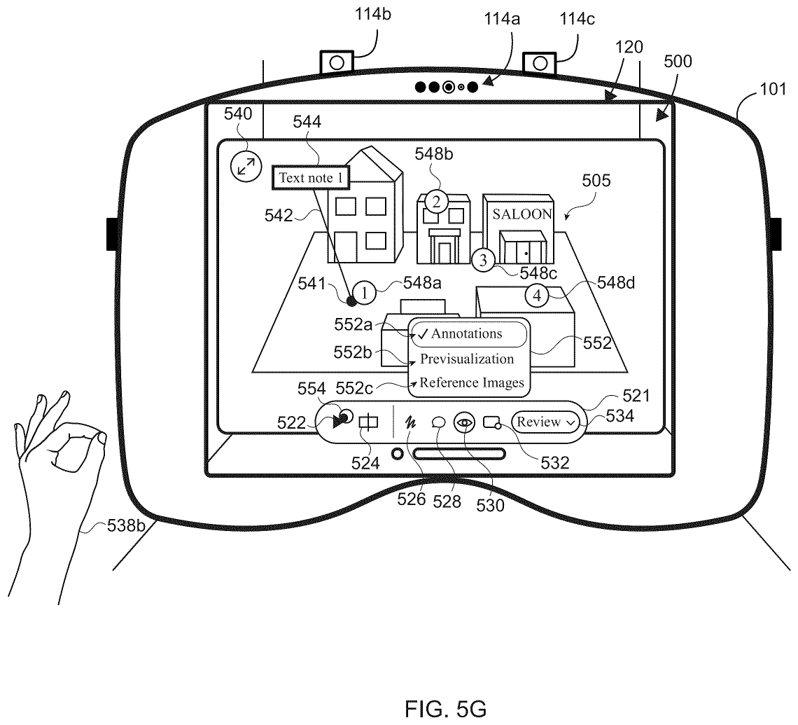

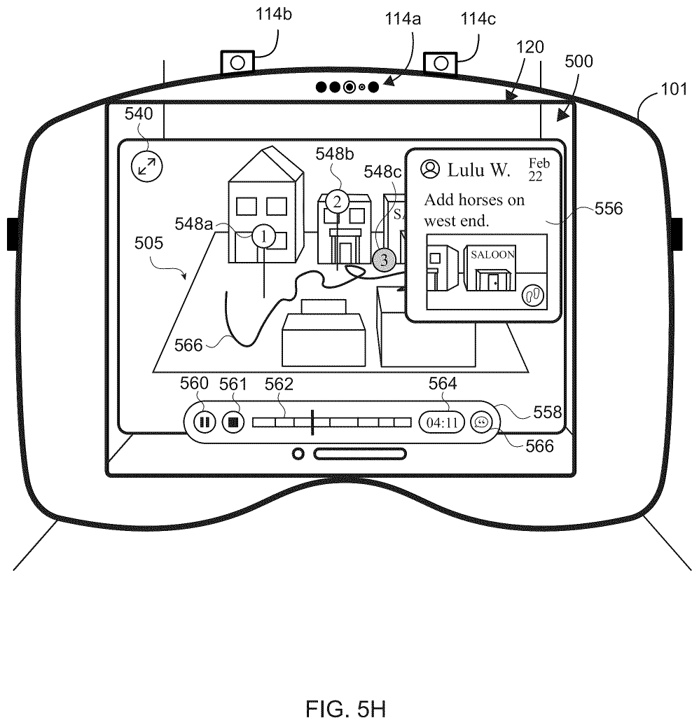

Some examples of the disclosure are directed to a virtual, three-dimensional model of the virtual scene. FIGS. 5A-5H, for example, illustrate example interactions with a user interface for interaction with a virtual scene according to some examples of the disclosure. By facilitating inspection and interaction with the virtual scene using the model and/or the user interface as illustrated in the above-described figures, electronic device 101 improves the efficiency of user interaction with the virtual scene.

In some examples, electronic device 101 displays a representation of a virtual scene within a three-dimensional environment and a plurality of selectable options for interacting with the representation of the virtual scene. For example, model 505 is a virtual object that includes a virtual assets corresponding to a virtual scene. In some examples, model 505 is part of and/or is displayed concurrently with a plurality of selectable options for inserting annotation(s) into the virtual scene and/or into the model 505. For example, menu 502 and menu 520 include selectable options that are respectively selectable to initiate modes of inserting annotations and/or review of the annotations.

Some examples described herein refer to selectable options that are selectable to cause some behavior or operations to be performed. It is understood that in such examples, electronic device 101 can detect an input directed to a particular selectable option, and in response to detecting that selectable option, can initiate a mode, disable the mode, and/or initiate an operation (e.g., displaying a menu and/or selectable options, initiating or display of virtual content, toggling selection of a virtual tool, initiating playback of virtual content, and/or some combination thereof). It is understood the aforementioned input can have one or more characteristics similar to or the same as other inputs described herein, such as an air gesture and/or an input directed to a peripheral computing device such as a stylus and/or an electronic pointing device used to direct a cursor in accordance with the position of the electronic device.

Menu 502 in FIG. 5A includes a plurality of selectable options to insert simulated markings into model 505. For example, selectable option 510 can be selectable to place a text-based annotation. As indicated by the height and/or dimensions of selectable option 510 in FIG. 5A, selectable option 510 is currently selected. As illustrated in FIGS. 5B-5F, electronic device can detect inputs initiating placement of an annotation while selectable option 510 is selected, and anchor a position of an annotation at a selected location within model 505, such as where attention of the user is directed when the inputs are detected.

Menu 502 can include additional or alternative selectable options. For example, tool 508 corresponds to a simulated erasing tool. While selected, electronic device 101 can detect an input targeting an annotation within model 505, and can delete the targeted annotation or a portion thereof. Selectable options 512 and 514 can correspond to simulated writing implements, such as simulated markers, pens, pencils, highlighters, and/or some combination thereof. Selectable option 516 can correspond to a simulated ruler, and when selected, can initiate display of a ruler that can be positioned within the three-dimensional environment 500 and/or model 505. While displayed, simulated marks can align along the dimensions of the ruler.

Selectable option 518 can correspond to a plurality of selectable options, each corresponding to a different visual characteristics such as a color, opacity, fill pattern, saturation, and/or some combination thereof of an annotation. While a particular selectable option of selectable option 518 is selected, annotations inserted into the virtual scene represented by model 505 can be displayed with the visual characteristic(s) of the selected selectable option of selectable options 518. For example, simulated handwriting can be displayed with a blue, red, or green color, when a corresponding colored selectable option of selectable options 518 is selected. Additionally or alternatively, a color of a virtual pin corresponding to selectable option 512 can be displayed with a color of the selected selectable option of selectable options 518.

Menu 521 can include one or more selectable options which when selected can change a currently selected interaction and/or review mode of the virtual scene. For example, selectable option 522 can correspond to review playback operations. In response to detecting selection of selectable option 522, electronic device 101 can initiate a replay of a spatial recording as described with reference to FIG. 3D, and/or a replay of a progression of insertion of annotations into the virtual scene represented by model 505. Selectable option 524 can correspond to display of a timeline representing the progression of insertion of the annotations. For example, a user of electronic device 101 can detect input selecting selectable option 524, and in response, can initiate display of a timeline of when annotations were inserted into the virtual scene (e.g., as illustrated in FIG. 5H) over a period of time.

Menu 521 can further include selectable options 526, 528, and 530, which can respectively be selected to enable an interaction mode associated with the virtual scene represented by model 505. For example, in response to detecting input selecting selectable option 526, electronic device 101 can initiate display of menu 520 and/or can enable an annotation insertion mode. In response to detecting input selecting selectable option 528, electronic device 101 can initiate display of a listing of the annotations associated with the virtual scene represented by model 505 (e.g., as illustrated in FIG. 5F). In response to detecting selection of selectable option 530, electronic device 101 can initiate display of a menu including selectable options for selecting a view of the virtual scene (e.g., as illustrated in FIG. 5G).

Menu 521 can further include a selectable option 534 that is selectable to initiate recording of a potentially collaborative inspection and/or annotation of the virtual scene and/or model 505. For example, in response to detecting input selecting selectable option 534, electronic device 101 can initiate a recording of annotation and/or commentary provided via a microphone and directed toward the virtual scene. The recording can span a period of time, and electronic device 101 can facilitate insertion of annotations into the virtual scene and/or model 505. While the recording is ongoing, electronic device 101 can detect input ceasing the recording, and in response, can cease the recording, defining an endpoint of a “review session” defined by the time of the recording. After the review session is recorded, electronic device 101 can load the review session, and facilitate playback of the review session (e.g., using selectable options 522 and 524).

In some examples, concurrent with the display of menu 502 and/or 521, electronic device 101 can display selectable option 540. Electronic device 101 can detect input selecting selectable option 540, and in response, can initiate display of the virtual scene represented by model 505 with a level of immersion relative to three-dimensional environment 500 that is greater than the level of immersion in FIG. 5A. It is understood that the level of immersion can include the degree to which virtual content included in the virtual scene occupies the viewport of electronic device 101. For example, a scale of the virtual scene can increase while a scale of the model 505 is maintained. Additionally or alternatively, a scale of the virtual scene and/or a scale of the model 505 can be increased (and/or electronic device 101 can cease display of model 505, instead display the virtual scene occupying the viewport of electronic device 101). For example, the virtual scene can occupy a greater portion of the viewport of electronic device 101 than before selectable option 540 is selected. As an example, the virtual scene can be displayed entirely consuming the viewport of electronic device 101, and the user's viewpoint relative to the virtual scene can change. The updated viewpoint relative to the virtual scene can be similar to as though the user is standing in a physical equivalent of the virtual scene. Thus, selecting selectable option 540 can cause electronic device 101 to display an immersive view of the virtual scene at a larger scale than the scale in FIG. 5A, facilitating a closer inspection of the content included in the virtual scene.

In FIG. 5B, electronic device 101 detects input represented by hand 538 forming an air pinch gesture. Attention 536 can correspond to a target of the user's input, such as a location on a ground of model 505. Because selectable option 510 is selected, electronic device 101 initiates an anchoring of an annotation within the model 505. For example, in FIG. 5C, electronic device 101 initiates display of visual indication 541 in response to detecting the input shown in FIG. 5B. From FIG. 5B through FIG. 5D, electronic device 101 detects the air pinch gesture formed by hand 538 is maintained. From FIG. 5C to FIG. 5D, electronic device 101 detects movement of hand 538. In response to detecting the movement of hand 538, electronic device 101 can initiate display of a lead line 542 shown in FIG. 5D having a first end anchored at the location indicated by visual indication 541 in FIG. 5B.

In some examples, the length and/or orientation of the lead line varies in accordance with movement of hand 538. For example, the lead line can move to extend toward a point defined by the air pinch gesture. The terminal point of the lead line (e.g., the end of lead line that is not anchored) can move in one or more directions and/or by one or more distances that are similar to, or the same as components of moving of hand 538 while the air gesture is maintained. Thus, the lead line can scale upwards, downwards, and/or be oriented in accordance with movement of hand 538.

In FIG. 5E, electronic device 101 detects ceasing of the air pinch formed by hand 538. In response to detecting the ceasing of the air pinch, electronic device 101 displays annotation 544 anchored at a second end of the lead line described with reference to FIG. 5D. The second anchor point can correspond to where the electronic device 101 detected that the lead line terminated when the air pinch ceased. In some examples, annotation 544 can include text and/or images provided by a user of electronic device 101 (e.g., typed text, voice-to-text input, and/or image(s) inserted into annotation 544). In some examples, electronic device 101 prompts the user to insert content into annotation 544 in response to detecting the air pinch cease.

In FIG. 5E, electronic device 101 detects input directed toward selectable option 528. In response to detecting the input, electronic device 101 can initiate display of annotation listing 546 as shown in FIG. 5F. In some examples, the annotation listing 546 can include a list of annotations that were inserted into the virtual scene corresponding to model 505. In some examples, the annotation listing 546 can correspond to a single review session. In some examples, annotation listing 546 can include annotations from a plurality of review sessions, each relating to reviewing the virtual scene represented by model 505. For example, listing 546 includes a plurality of list elements, including annotations 546a (e.g., “John S. Just Now Can we add more boxes?”), 546b (e.g., “John S. 10 min Lets add some more props here.”), 546c (e.g., “Lulu W. February 22 Add horses on west end”), and 546d (e.g., “Lulu W. February 22 Lighting needs refinement).

As shown in FIG. 5F, annotations 546a through 546d can be each displayed with visual indication(s) of the author of an annotation such as an image representing the author and/or a name of the author. Additionally, annotations 546a through 546d includes information indicating a time that the annotation was inserted. For example, annotation 546a corresponds to annotation 544, entered recently by the user of electronic device 101 (e.g., “Just now”).

In some examples, in response to detecting input directed toward selectable option 528, electronic device 101 displays annotation markers 548a through 548d. It is understood that annotation markers 548a through 548d can respectively correspond to annotations 546a through 546d (e.g., annotation marker 548a corresponds to annotation 546a, annotation marker 548b corresponds to annotation 546b, etc.). Annotation markers 548a through 548d respectively indicate locations that annotations were inserted into the virtual scene, and can each be included in and/or overlay model 505.

In FIG. 5F, electronic device 101 detects input provided by hand 538b while attention 550 is directed to selectable option 530. In response to detecting the input, electronic device 101 displays a menu 552 as shown in FIG. 5G. In some examples, menu 552 includes a plurality of selectable options including selectable options 552a through 552c respectively associated with a view of model 505. For example, selectable option 552a in FIG. 5G is currently selected (e.g., “Annotations), and representations of annotations are displayed overlaying model 505.

Selectable option 552b can correspond to a previsualization viewing mode of model 505, which when selected, can cause electronic device 101 to display virtual content for creating and/or using model 505. For example, the virtual content can include text, images, models, lists of video shots, and/or storyboards relating to content that can be generated using the virtual scene represented by model 505. Selectable option 552c can correspond to a reference image viewing mode, which when selected, can cause electronic device 101 to display reference images and/or two and three-dimensional objects used to as visual references to create content, such as creating virtual models of physical objects, textures, and/or creating animations.

In FIG. 5G, electronic device 101 detects input from hand 538b while attention 554 is directed to selectable option 522. In response to detecting the input, electronic device 101 initiates display of user interface for a review session. Additionally or alternatively, the electronic device 101 can initiate playback of the review session. The review session playback, for example, can include display of annotation markers, annotations, display of media, playback of audio, and/or the like at times corresponding to when such virtual and/or media content were provided into an ongoing review session.

In some examples, the review session user interface includes a plurality of visual indications and/or selectable options, such as those included in controls menu 558. Controls menu 558 includes a selectable option 560 that is selectable to cease the playback of the review session.

In order to indicate the progression of the playback of a review session, control menu 558 can include scrubber bar 562. Scrubber bar 562 can include a visual play head that moves along the lateral dimension of scrubber bar 562 to illustrate the progression of playback relative to a duration of the recording. Additionally or alternatively, scrubber bar 562 can include visual indications overlaying scrubber bar 562, indicating the time that those annotations were inserted into the virtual scene. In some examples, the annotations markers 548a through 548d are displayed overlaying the model 505, irrespective of a time that the annotations were entered in the scene. In some examples, electronic device 101 displays annotations markers 548a through 548d when the review session playback reaches times that annotations associated with annotation markers 548a through 548d were inserted into the virtual scene. Additionally or alternatively, when review session playback reaches a time corresponding to an annotation, electronic device 101 can display the annotation, such as annotation 556.

Annotation 556 as shown in FIG. 5H includes information identifying an author of annotation 556, a timestamp of annotation 556, and/or additional or alternative media (e.g., simulated marking that the author entered while creating that annotation, screenshots captured while creating the annotation, and/or video captured while creating the annotation). Additionally or alternatively, a path 566 of a user of a device while creating an annotation can be displayed and/or animated (e.g., a user of electronic device 101 or another electronic device 101 collaborating with electronic device 101). In some examples, the path 566 is gradually animated to visually indicate the progression of the author of annotation 556 as review session playback progresses.

In some examples, control menu 558 can include a selectable option 564 which when selected, initiates display of captions transcribing vocal annotations directed toward the virtual scene. For example, before or during the review session playback, electronic device 101 can detect input selecting selectable option 564. In response to detecting such input, electronic device 101 can initiate display of captions when the review session reaches a time that a voice annotation was directed toward the virtual scene.

The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some examples, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some examples, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone).

A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some examples a representation of a physical environment (e.g., displayed via virtual passthrough or optical passthrough) can be partially or fully obscured by a virtual environment. In some examples, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some examples, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed.

In some examples, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some examples, the background content is included in a background over which the virtual content is displayed (e.g., background content in the representation of the physical environment). In some examples, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some examples, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency.

In some examples, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some examples, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some examples, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Therefore, according to the above, some examples of the disclosure are directed to a method performed at a computer system in communication with one or more input devices and a display. In some examples, the method comprises, while the computer system is participating in a communication session that includes one or more participants, and while displaying a virtual scene from a viewpoint of a user of the computer system within a three-dimensional environment of the user, obtaining, via the one or more input devices, first information including a request to display a first annotation at a position within the three-dimensional environment wherein correspondence of the first annotation to a respective position within the three-dimensional environment is determined based on a context of the user's interaction with the three-dimensional environment. In some examples, in response to obtaining the first information, and in accordance with a determination that the first annotation corresponds to a first position in the virtual scene, the method can comprise displaying a first representation of the first annotation at the first position. In some examples, in response to obtaining the first information, and in accordance with a determination that the first annotation corresponds to a second position in the virtual scene, the method can comprise displaying the first representation of the first annotation at the second position.

Additionally or alternatively, in some examples, the first representation includes a positional marker including a graphical representation indicating one or more portions of the virtual scene.

Additionally or alternatively, in some examples, the first representation includes a simulated marking having one or more visual characteristics based on a simulated marking implement selected while the first information is obtained.

Additionally or alternatively, in some examples, the context of the user's interaction with the three-dimensional environment is based on a target of attention of the user. In some examples, the method can further comprise before displaying the first representation of the first annotation, displaying, via the display, a visual indication of the target of the attention of the user.

Additionally or alternatively, in some examples, the target of the attention of the user is based on a position of a gaze of the user relative to the three-dimensional environment.

Additionally or alternatively, in some examples, the target of the attention of the user is based on a spatial relationship between one or more portions of a body of the user, the viewpoint of the user, and the three-dimensional environment.

Additionally or alternatively, in some examples, the first information is provided by a participant of the communication session different from the user of the computer system, and the first annotation has one or more visual characteristics that visually indicate that the participant provided the first information.

Additionally or alternatively, in some examples, the one or more visual characteristics include a color of the first representation.

Additionally or alternatively, in some examples, the method can further comprise, while displaying the first representation of the first annotation, detecting, via the one or more input devices, an input directed to the first representation of the first annotation, and in response to detecting the input directed to the first representation, presenting contextual information included in the first information.

Additionally or alternatively, in some examples, the presenting of the contextual information includes presenting audio associated with the first annotation recorded by a participant of the communication session.

Additionally or alternatively, in some examples, the presenting of the contextual information includes displaying text associated with the first annotation recorded by a participant of the communication session.

Additionally or alternatively, in some examples, the presenting of the contextual information includes displaying a representation of a participant that provided the first information moving within the three-dimensional environment.

Additionally or alternatively, in some examples, the method can further comprise while the first representation of the first annotation is included within the three-dimensional environment, obtaining second information, different from the first information, requesting display of a user interface directed to displaying a plurality of representations of a plurality of annotations including the first annotation. In some examples, the method can further comprise, in response to obtaining the second information, displaying, via the display, at least a portion of the plurality of representations of the plurality of annotations, including a second representation of the first annotation, different from the first representation of the first annotation.

Additionally or alternatively, in some examples, one or more of the plurality of representations are visually grouped in accordance with one or more characteristics of respective annotations of the plurality of annotations.

Additionally or alternatively, in some examples, the one or more characteristics include an originator of respective annotations of the plurality of annotations.

Additionally or alternatively, in some examples, the one or more characteristics include one or more times that information corresponding to respective annotations of the plurality of annotations were obtained.

Additionally or alternatively, in some examples, the one or more characteristics include a category of information included in respective annotations of the plurality of annotations.

Additionally or alternatively, in some examples, the first information includes an air gesture performed by one or more portions of a body of the user.

Additionally or alternatively, in some examples, the method can further comprise, while the computer system is participating in the communication session that includes the one or more participants, and while displaying the virtual scene from the viewpoint of the user of the computer system, obtaining, via the one or more input devices, second information including a request to include a second annotation within the three-dimensional environment. In some examples, the method can further comprise, in response to obtaining the second information, presenting feedback indicating a spatial relationship between a position of the second annotation within the three-dimensional environment and the viewpoint of the user.

Additionally or alternatively, in some examples, the feedback includes audio that is generated with a three-dimensional environment effect emulating the sensation of a physical audio source generating the audio from the position of the second annotation.

Additionally or alternatively, in some examples, the method can further comprise, while the computer system is participating in the communication session that includes the one or more participants, displaying, via the display, a representation of a first participant of the one or more participants of the communication session at a second position within the three-dimensional environment.

Additionally or alternatively, in some examples, the representation of the first participant is an expressive avatar including one or more simulated body parts corresponding to physical body parts of the first participant.

Additionally or alternatively, in some examples, the method can further comprise, while displaying the representation of the first participant at the second position within the three-dimensional environment, obtaining second information including a request to move the representation of the first participant within the three-dimensional environment. In some examples, the method can further comprise, in response to obtaining the second information, moving the representation of the first participant from the second position to a third position in accordance with the request to move the representation of the first participant.

Additionally or alternatively, in some examples, the method can further comprise, while displaying the representation of the first participant at the second position within the three-dimensional environment, obtaining second information including a request to display a target of attention of the first participant. In some examples, the method can further comprise, in response to obtaining the second information, displaying, via the display, a visual indication of the attention at a third position within the three-dimensional environment.

Additionally or alternatively, in some examples, a visual appearance of the first representation of the first annotation corresponds to content included in the first annotation.

Additionally or alternatively, in some examples, the correspondence between the first annotation and the respective position within the three-dimensional environment is based on a spatial relationship between one or more portions of the user's body relative to the three-dimensional environment.

Additionally or alternatively, in some examples, the context of the user's interaction with the three-dimensional environment is associated with one or more words spoken by the user of the computer system included in the first information.

Additionally or alternatively, in some examples, the first position is a predetermined distance from the viewpoint of the user.

Additionally or alternatively, in some examples, the method can further comprise, while displaying the virtual scene from the viewpoint of the user, obtaining second information including a request to capture a two-dimensional image of the virtual scene, wherein a portion of the three-dimensional environment is visible via a viewport of the computer system when the second information is obtained. In some examples, the method can further comprise, in response to obtaining the second information, displaying, via the display, a virtual object including a two-dimensional image of the three-dimensional environment including the portion of the three-dimensional environment.

Additionally or alternatively, in some examples, the displaying of the virtual object includes displaying an animation that includes, displaying the virtual object with a first size corresponding to the viewport of the computer system in response to the second information. In some examples, the animation includes, after displaying the virtual object, shrinking the virtual object to a second size, and concurrent with the shrinking of the virtual object, maintaining visibility of the portion of the three-dimensional environment via the viewport.

Additionally or alternatively, in some examples, a simulated thickness of the virtual object is less than a simulated thickness threshold.

Additionally or alternatively, in some examples, the method can further comprise, while displaying the virtual object with a level of visual prominence that is a first level of visual prominence relative to the three-dimensional environment and while the viewpoint of the user is a first viewpoint, detecting, via the one or more input devices, a change in the viewpoint of the user to a second viewpoint. In some examples, the method can further comprise, in response to detecting the change in the viewpoint, decreasing the level of visual prominence to a second level of visual prominence, less than the first level of visual prominence.

Additionally or alternatively, in some examples, the method can further comprise while displaying the virtual object, detecting, via the one or more input devices, a request to display a simulated marking within the virtual object including movement of one or more portions of a body of the user. In some examples, the method can further comprise, in response to detecting the request to display the simulated marking, displaying the simulated marking in accordance with the movement.

Additionally or alternatively, in some examples, the method can further comprise, while displaying the virtual object, detecting, via the one or more input devices, a request to select virtual content included in the virtual object. In some examples, the method can further comprise, in response to the request to select virtual content, displaying a visual indication of a target of the request within the virtual object.

Some examples of the disclosure are directed to an electronic device comprising one or more processors, memory, and one or more programs stored in the memory and configured to be executed by the one or more processors, the one or more programs including instructions for performing a method as described herein.

Some examples of the disclosure are directed to a non-transitory computer readable storage medium storing one or more programs, the one or more programs comprising instructions, which when executed by one or more processors of an electronic device, cause the electronic device to perform a method as described herein.

Some examples of the disclosure are directed to an electronic device, comprising, one or more processors, memory, and means for performing a method as described herein.

Some examples of the disclosure are directed to an information processing apparatus for use in an electronic device, the information processing apparatus comprising means for performing a method as described herein.

Some examples of the disclosure are directed to an electronic device in communication with one or more input devices and a display, the electronic device comprising one or more processors, memory, one or more programs stored in the memory and configured to be executed by the one or more processors, the one or more programs including instructions for performing a method. In some examples, the method can comprise, while the computer system is participating in a communication session that includes one or more participants, and while displaying a virtual scene from a viewpoint of a user of the computer system within a three-dimensional environment of the user, obtaining, via the one or more input devices, first information including a request to display a first annotation at a position within the three-dimensional environment wherein correspondence of the first annotation to a respective position within the three-dimensional environment is determined based on a context of the user's interaction with the three-dimensional environment. In some examples, the method can comprise, in response to obtaining the first information, in accordance with a determination that the first annotation corresponds to a first position in the virtual scene, displaying a first representation of the first annotation at the first position, and in accordance with a determination that the first annotation corresponds to a second position in the virtual scene, displaying the first representation of the first annotation at the second position.

Some examples of the disclosure are directed to a non-transitory computer readable storage medium storing one or more programs, the one or more programs comprising instructions, which when executed by one or more processors of an electronic device in one or more input devices and a display, cause the electronic device to perform a method. In some examples, the method can comprise, while the computer system is participating in a communication session that includes one or more participants, and while displaying a virtual scene from a viewpoint of a user of the computer system within a three-dimensional environment of the user, obtaining, via the one or more input devices, first information including a request to display a first annotation at a position within the three-dimensional environment wherein correspondence of the first annotation to a respective position within the three-dimensional environment is determined based on a context of the user's interaction with the three-dimensional environment. In some examples, the method can comprise, in response to obtaining the first information, in accordance with a determination that the first annotation corresponds to a first position in the virtual scene, displaying a first representation of the first annotation at the first position, and in accordance with a determination that the first annotation corresponds to a second position in the virtual scene, displaying the first representation of the first annotation at the second position.

The foregoing description, for purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the invention and its practical applications, to thereby enable others skilled in the art to best use the invention and various described examples with various modifications as are suited to the particular use contemplated.

What is claimed is:

1. A method comprising:
at a computer system in communication with one or more input devices and a display:
while the computer system is participating in a communication session that includes one or more participants, and while displaying a virtual scene from a viewpoint of a user of the computer system within a three-dimensional environment of the user:
obtaining, via the one or more input devices, first information including a request to display a first annotation at a position within the three-dimensional environment wherein correspondence of the first annotation to a respective position within the three-dimensional environment is determined based on a context of the user's interaction with the three-dimensional environment; and
in response to obtaining the first information:
in accordance with a determination that the first annotation corresponds to a first position in the virtual scene, displaying a first representation of the first annotation at the first position; and
in accordance with a determination that the first annotation corresponds to a second position in the virtual scene, displaying the first representation of the first annotation at the second position.

2. The method of claim 1, wherein the first representation includes a positional marker including a graphical representation indicating one or more portions of the virtual scene.

3. The method of claim 1, wherein the first representation includes a simulated marking having one or more visual characteristics based on a simulated marking implement selected while the first information is obtained.

4. The method of claim 1, wherein the context of the user's interaction with the three-dimensional environment is based on a target of attention of the user, the method further comprising:
before displaying the first representation of the first annotation, displaying, via the display, a visual indication of the target of the attention of the user.

5. The method of claim 4, wherein the target of the attention of the user is based on a position of a gaze of the user relative to the three-dimensional environment.

6. The method of claim 4, wherein the target of the attention of the user is based on a spatial relationship between one or more portions of a body of the user, the viewpoint of the user, and the three-dimensional environment.

7. The method of claim 1, wherein the first information is provided by a participant of the communication session different from the user of the computer system, and the first annotation has one or more visual characteristics that visually indicate that the participant provided the first information.

8. The method of claim 1, further comprising:
while displaying the first representation of the first annotation, detecting, via the one or more input devices, an input directed to the first representation of the first annotation; and
in response to detecting the input directed to the first representation, presenting contextual information included in the first information.

9. The method of claim 8, wherein the presenting of the contextual information includes presenting audio associated with the first annotation recorded by a participant of the communication session.

10. The method of claim 1, further comprising:
while the first representation of the first annotation is included within the three-dimensional environment, obtaining second information, different from the first information, requesting display of a user interface directed to displaying a plurality of representations of a plurality of annotations including the first annotation; and
in response to obtaining the second information, displaying, via the display, at least a portion of the plurality of representations of the plurality of annotations, including a second representation of the first annotation, different from the first representation of the first annotation.

11. The method of claim 1, wherein the first information includes an air gesture performed by one or more portions of a body of the user.

12. The method of claim 1, further comprising:
while the computer system is participating in the communication session that includes the one or more participants, and while displaying the virtual scene from the viewpoint of the user of the computer system, obtaining, via the one or more input devices, second information including a request to include a second annotation within the three-dimensional environment; and
in response to obtaining the second information, presenting feedback indicating a spatial relationship between a position of the second annotation within the three-dimensional environment and the viewpoint of the user.

13. The method of claim 1, further comprising:
while the computer system is participating in the communication session that includes the one or more participants, displaying, via the display, a representation of a first participant of the one or more participants of the communication session at a second position within the three-dimensional environment.

14. The method of claim 1, further comprising:
receiving, via the one or more input devices, second information, different from the first information, from a respective computer system, other than the computer system, that is communicating information to the computer system that is used to display the virtual scene at the computer system; and
in response to receiving the second information, displaying, via the display, a second annotation at a respective position in the three-dimensional environment specified by the respective computer system.

15. The method of claim 1, wherein the correspondence between the first annotation and the respective position within the three-dimensional environment is based on a spatial relationship between one or more portions of the user's body relative to the three-dimensional environment.

16. The method of claim 1, wherein the context of the user's interaction with the three-dimensional environment is associated with one or more words spoken by the user of the computer system included in the first information.

17. The method of claim 1, wherein the first position is a predetermined distance from the viewpoint of the user.

18. The method of claim 1, further comprising:
while displaying the virtual scene from the viewpoint of the user, obtaining second information including a request to capture a two-dimensional image of the virtual scene, wherein a portion of the three-dimensional environment is visible via a viewport of the computer system when the second information is obtained; and
in response to obtaining the second information, displaying, via the display, a virtual object including the two-dimensional image of the three-dimensional environment including the portion of the three-dimensional environment.

19. An electronic device in communication with one or more input devices and a display, the electronic device comprising:
one or more processors;
memory; and
one or more programs stored in the memory and configured to be executed by the one or more processors, the one or more programs including instructions for performing a method comprising:
while the electronic device is participating in a communication session that includes one or more participants, and while displaying a virtual scene from a viewpoint of a user of the electronic device within a three-dimensional environment of the user:
obtaining, via the one or more input devices, first information including a request to display a first annotation at a position within the three-dimensional environment wherein correspondence of the first annotation to a respective position within the three-dimensional environment is determined based on a context of the user's interaction with the three-dimensional environment; and
in response to obtaining the first information:
in accordance with a determination that the first annotation corresponds to a first position in the virtual scene, displaying a first representation of the first annotation at the first position; and
in accordance with a determination that the first annotation corresponds to a second position in the virtual scene, displaying the first representation of the first annotation at the second position.

20. A non-transitory computer readable storage medium storing one or more programs, the one or more programs comprising instructions, which when executed by one or more processors of an electronic device in communication with one or more input devices and a display, cause the electronic device to perform a method comprising:
while the electronic device is participating in a communication session that includes one or more participants, and while displaying a virtual scene from a viewpoint of a user of the electronic device within a three-dimensional environment of the user:
obtaining, via the one or more input devices, first information including a request to display a first annotation at a position within the three-dimensional environment wherein correspondence of the first annotation to a respective position within the three-dimensional environment is determined based on a context of the user's interaction with the three-dimensional environment; and
in response to obtaining the first information:
in accordance with a determination that the first annotation corresponds to a first position in the virtual scene, displaying a first representation of the first annotation at the first position; and
in accordance with a determination that the first annotation corresponds to a second position in the virtual scene, displaying the first representation of the first annotation at the second position.
